(19) United States
(12) Patent Application Publication
(10) Pub. No.: US 2019/0351601 A1
(43) Pub. Date: Nov. 21, 2019

(54) SPRAY PROCESSES AND METHODS FOR FORMING LIQUID-IMPREGNATED SURFACES

(71) Applicant: LiquiGlide Inc., Cambridge, MA (US)

(72) Inventors: Kripa VARANASI, Lexington, MA (US); J. David SMITH, Arlington, MA (US); Jose YAGUE, Barcelona (ES); Brian JORDAN, Winchester, MA (US); Charles W. HIBBEN, Darien, CT (US); Jiapeng XU, Shenzhen (CN); Tao CONG, Arlington, MA (US)

(21) Appl. No.: 16/527,888

(22) Filed: Jul. 31, 2019

Related U.S. Application Data
(63) Continuation of application No. 14/668,444, filed on Mar. 25, 2015, now abandoned.
(60) Provisional application No. 61/969,971, filed on Mar. 25, 2014.

(51) Int. Cl. B29C 49/00; B05D 5/08

(52) U.S. Cl. CPC B29C 49/00; B05D 5/02; B05D 5/08

(57) ABSTRACT

In some embodiments, a method of producing a liquid-impregnated surface includes forming a solid particle suspension including a plurality of solid particles with an average dimension of between about 5 nm and about 200 μm. The solid particle suspension is applied to a surface by spray-depositing the solid particle suspension onto the surface. An impregnating liquid is also applied to the surface. The plurality of solid particles and the impregnating liquid collectively form a liquid-impregnated surface. The impregnating liquid can be applied after the solid particle suspension is applied, or the solid particle suspension can include the impregnating liquid, such that the solid particle suspension and the impregnating liquid are concurrently spray-deposited onto the surface.

### CROSS-REFERENCE TO RELATED APPLICATION

This application claims priority to and the benefit of U.S. Provisional Patent Application No. 61/969,971, filed on Mar. 25, 2014, entitled, “Spray Processes and Methods for Forming Liquid Impregnated Surfaces,” the disclosure of which is incorporated herein by reference in its entirety.

### BACKGROUND

Embodiments described herein relate to methods of forming liquid-impregnated surfaces, and in particular spray coating processes for forming liquid-impregnated surfaces.

The advent of micro/nano-engineered surfaces in the last decade has opened up new techniques for enhancing a wide variety of physical phenomena in thermofluids sciences. For example, the use of micro/nano surface textures has provided non-wetting surfaces capable of achieving less viscous drag, reduced adhesion to ice and other materials, self-cleaning, and water repellency. These improvements result generally from diminished contact (i.e., less wetting) between the solid surfaces and adjacent liquids.

One type of non-wetting surface of interest is a super hydrophobic surface. In general, a super hydrophobic surface includes micro/nano-scale roughness on an intrinsically hydrophobic surface, such as a hydrophobic coating. Super hydrophobic surfaces resist contact with water by virtue of an air-water interface within the micro/nano surface textures.

One of the drawbacks of existing non-wetting surfaces (e.g., superhydrophobic, superoleophobic, and supermetallophobic surfaces) is that they are susceptible to impalement, which destroys the non-wetting capabilities of the surface. Impalement occurs when an impinging liquid (e.g., a liquid droplet or liquid stream) displaces the air entrapped within the surface textures. Previous efforts to prevent impalement have focused on reducing surface texture dimensions from micro-scale to nano-scale.

Another drawback with existing non-wetting surfaces is that they are susceptible to ice formation and adhesion. For example, when frost forms on existing super hydrophobic surfaces, the surfaces become hydrophilic. Under freezing conditions, water droplets can stick to the surface, and ice can accumulate. Removal of the ice can be difficult because the ice may interlock with the textures of the surface. Similarly, when these surfaces are exposed to solutions saturated with salts, for example as in desalination or oil and gas applications, scale builds on the surfaces and results in loss of functionality. Similar limitations of existing non-wetting surfaces include problems with hydrate formation, and formation of other organic or inorganic deposits on the surfaces.

Thus, there is a need for non-wetting surfaces that are more robust. In particular, there is a need for non-wetting surfaces that are more durable and can maintain highly non-wetting characteristics even after repeated use.

### SUMMARY

Embodiments described herein relate generally to methods of producing liquid-impregnated surfaces and in particular, to spray coating processes for producing liquid-impregnated surfaces. In some embodiments, a method of producing a liquid-impregnated surface includes forming a solid particle suspension including a plurality of solid particles with an average dimension of between about 5 nm and about 200 μm. The solid particle suspension is applied to a surface by spray-depositing the solid particle suspension onto the surface. An impregnating liquid is also applied to the surface. The plurality of solid particles and the impregnating liquid collectively form a liquid-impregnated surface. The impregnating liquid can be applied after the solid particle suspension is applied, or the solid particle suspension can include the impregnating liquid, such that the solid particle suspension and the impregnating liquid are concurrently spray-deposited onto the surface. In some embodiments, a spray coating process can include improving the surface roughness of the deposited solid particles by controlling an atomizing air pressure. In some embodiments, the surface roughness of spray coated solid features can be improved by controlling the drying conditions and drying time of deposited solid particles. In some embodiments, a liquid-impregnated surface can be formed by depositing solid particles and impregnating liquid together on the surface. In some embodiments, the surface texture can be improved by modifying a temperature (i.e., heating or cooling) of a solid particle suspension while spray-depositing onto the surface. In some embodiments, the surface texture can be controlled by modifying a temperature (i.e., heating or cooling) of the surface before or after spray coating the solid particle suspension on the surface.

### BRIEF DESCRIPTION OF THE DRAWINGS

FIG. 1A is a schematic cross-section view of a product contacting a conventional non-wetting surface, and FIG. 1B shows the conventional non-wetting surface such that the product has impaled the surface.

FIG. 2 shows a schematic cross-section of a liquid-impregnated surface according to an embodiment.

FIGS. 3A and 3B show an apparatus for gripping a neck of a container and rotating the container in a first configuration and a second configuration, respectively, according to an embodiment.

FIGS. 4A and 4B show an apparatus for clamping the neck of a container and spray coating an inner surface of the container in a first configuration and a second configuration respectively, according to an embodiment.

FIGS. 5A and 5B show an apparatus for clamping the base of a container in a first configuration and a second configuration, respectively and rotating the container to allow homogeneous deposition of a solid particle solution and/or an impregnating liquid, delivered by a spray coater nozzle to an interior volume of the container on the inner surface of the container, according to an embodiment.

FIG. 6 shows an interferometry image of an inner surface of a PET container coated with a single coat of a solid particle solution.

FIG. 7 shows an interferometry image of an inner surface of a PET container coated with five coats of a solid particle solution.

FIGS. 8, 9, and 10 show interferometry images of an inner surface of a first PET bottle, a second PET bottle, and a third PET bottle, respectively which are coated with a solid particle solution at an atomizing air pressure of 30 psi, 60 psi, and 90 psi, respectively

FIG. 11 shows the weight of a solid particle coating on inner surface of various PET containers dried in ambient conditions, in an oven, or by a forced stream of nitrogen, at various time points after deposition of the spray coating.

FIGS. 12A and 12B show optical images of a first PET bottle and a second PET bottle, each of which includes an inner surface spray coated with a heated solid particle solution.

FIG. 13 shows an interferometry image of the solid particle coating spray coating deposited on the inner surface of the second bottle shown in FIG. 12B.

FIG. 14 shows an optical image of a PET bottle which includes an inner surface coated with a textured solid deposited by spraying a molten solid.

FIG. 15 shows an interferometry of the solid particle coating spray coating deposited on the inner surface of the bottle shown in FIG. 14.

FIG. 16 shows an optical image of a PET bottle which includes an inner surface coated with a melted solid particle solution and an impregnating liquid to form a liquid-impregnated surface.

FIG. 17 shows an interferometry image of a solid particle coating disposed on a surface.

FIG. 18 shows an interferometry image of the solid particle coating of FIG. 17 after spraying with a hot solvent.

### DETAILED DESCRIPTION

Embodiments described herein relate generally to methods of producing liquid-impregnated surfaces, and in particular, to spray coating processes for producing liquid-impregnated surfaces. In some embodiments, a method of producing a liquid-impregnated surface includes forming a solid particle solution including a plurality of solid particles with an average dimension of between about 5 nm and about 200 μm. The solid particle solution is applied to a surface by spray-depositing the solid particle solution onto the surface. An impregnating liquid is also applied to the surface. The plurality of solid particles and the impregnating liquid collectively form a liquid-impregnated surface. The impregnating liquid can be applied after the solid particle solution is applied, or the solid particle solution can include the impregnating liquid, such that the solid particle solution and the impregnating liquid are concurrently spray-deposited onto the surface. In some embodiments, a spray coating process can include improving the surface roughness of the deposited solid particles by controlling an atomizing air pressure. In some embodiments, the surface roughness of spray coated solid features can be improved by controlling the drying conditions and drying time of deposited solid particles. In some embodiments, a liquid-impregnated surface can be formed by depositing solid particles and impregnating liquid together on the surface. In some embodiments, the surface texture can be improved by modifying a temperature (i.e., heating or cooling) of a solid particle solution while spray-depositing onto the surface. In some embodiments, the surface texture can be controlled by modifying a temperature (i.e., heating or cooling) of the surface before or after spray coating the solid particle solution on the surface.

Some known surfaces with designed chemistry and roughness (e.g., “engineered surfaces”), possess substantial non-wetting (hydrophobic) properties, which can be extremely useful in a wide variety of commercial and technological applications. Inspired by nature, these known hydrophobic surfaces include air pockets trapped within the micro or nano texture of the surface which diminishes the contact angle of such hydrophobic surfaces with the liquid, for example, water, an aqueous liquid, or any other aqueous product. As long as these air pockets are stable, the surface maintains non-wetting characteristics. Such known hydrophobic surfaces that include air pockets, however, present certain limitations including, for example: i) the air pockets can be collapsed by external wetting pressures, ii) the air pockets can diffuse away into the surrounding liquid, iii) the surface can lose robustness upon damage to the texture, iv) the air pockets may be displaced by low surface tension liquids unless special texture design is implemented, and v) condensation or frost nuclei, which can form at the nanoscale throughout the texture, can completely transform the wetting properties and render the textured surface highly wetting.

Liquid-impregnated surfaces described herein, include impregnating liquids that are impregnated in a surface that includes a matrix of solid features (i.e., a micro-textured surface) defining interstitials regions, such that the interstitial regions include pockets of impregnating liquid. The impregnating liquid is configured to wet the solid surface preferentially and adhere to the micro-textured surface with strong capillary forces, such that the contact liquid has an extremely high advancing contact angle and an extremely low roll off angle (e.g., a roll off angle of about 1 degree and a contact angle of greater than about 100 degrees). This enables the contact liquid to displace with substantial ease on the liquid-impregnated surface. Therefore, the liquid-impregnated surfaces described herein, provide certain significant advantages over conventional super hydrophobic surfaces including: (i) the liquid-impregnated surfaces have low hysteresis, (ii) such liquid-impregnated surfaces can have self cleaning properties, (iii) can withstand high drop impact pressure (i.e., are wear resistant), (iv) can self heal by capillary wicking upon damage; and (v) enhance condensation. Examples of liquid-impregnated surfaces, methods of making liquid-impregnated surfaces and applications thereof, are described in U.S. Pat. No. 8,574,704, entitled “Liquid-Impregnated Surfaces, Methods of Making, and Devices Incorporating the Same,” issued Nov. 5, 2013, and U.S. Publication No. 2014/0178611, entitled “Apparatus and Methods Employing Liquid-Impregnated Surfaces,” published Jun. 26, 2014, the contents of which are hereby incorporated herein by reference in their entirety. Examples of materials used for forming the solid features on the surface, impregnating liquids, applications involving edible contact liquids, are described in U.S. Pat. No. 8,535,779, entitled “Self-Lubricating Surfaces for Food Packaging and Food Processing Equipment,” filed Jul. 17, 2012, the contents of which are hereby incorporated herein by reference in their entirety. Examples of non-toxic liquid impregnated surfaces are described in U.S. Publication No. 2015/0076030 (also referred to as “the '030 publication”), entitled “Non-toxic Liquid,” published Mar. 19, 2015, the content of which is hereby incorporated herein by reference in its entirety.

Additionally, methods of producing liquid-impregnated surfaces, as described herein, include spray-depositing impregnating liquids and/or a solid particle solution. The impregnating liquid can be applied after the solid particle solution is applied, or the solid particle solution can include the impregnating liquid, such that the solid particle solution and the impregnating liquid are concurrently spray-deposited onto the surface (i.e., the solid particle solution and the impregnating liquid are “co-deposited”). Co-deposition of the solid particle solution and the impregnating liquid is faster and more efficient than serial methods of fabricating engineered surfaces, requires less equipment (e.g., one application device, such as a sprayer, rather than two), and can therefore result in a higher manufacturing throughput. Furthermore, the use of a sprayer as an application tool allows for the control of spray pressure, temperature, directionality, and uniformity of thickness and/or distribution of the applied material(s).

Many different methods can be used to form liquid-impregnated surfaces. Among these methods, spray coating processes can allow facile deposition of solid particles that can form the textured surface and/or the impregnating liquid at a low cost. Spray coating processes and methods described herein allow for formation of a textured surface (i.e., a surface having a plurality of solid features deposited thereon) such that the surface roughness is improved and the textured surface is more durable. In some embodiments, a liquid-impregnated surface includes a first surface having a first roll off angle. A plurality of solid features disposed on the first surface such that the plurality of solid features define interstitial regions between the plurality of solid features. An impregnating liquid is disposed in the interstitial regions. The interstitial regions are dimensioned and configured such that the impregnating liquid is retained in the interstitial region by capillary forces. The impregnating liquid disposed in the interstitial regions defines a second surface having a second roll off angle less than the first roll off angle.

In some embodiments, a spray coating process for forming liquid-impregnated surfaces includes depositing multiple spray coats of solids on a surface for improving texture and roughness of overall coating. In some embodiments, a spray coating process can include improving the surface roughness of the deposited solid particles by controlling the atomizing air pressure. In some embodiments, the surface roughness of sprayed solid coatings can be improved by controlling the drying conditions and drying time of deposited solid particles. In some embodiments, a liquid-impregnated surface can be formed by depositing solid particles and impregnating liquid together on the surface. In some embodiments, the surface texture can be improved by controlling the temperature of a solid particle solution sprayed on the surface. In some embodiments, the surface texture can be controlled by heating or cooling the surface before or after spray coating the solid particle solution on the surface.

As used herein, the term “about” and “approximately” generally mean plus or minus 10% of the value stated, for example about 250 μm would include 225 μm to 275 μm, approximately 1,000 μm would include 900 μm to 1,100 μm.

As used herein, the term “contact liquid”, “fluid” and “product” are used interchangeably to refer to a solid or liquid that flows, for example a non-Newtonian fluid, a Bingham fluid, or a thixotropic fluid and is contact with a liquid-impregnated surface, unless otherwise stated.

As used herein, the term “roll off angle” refers to the inclination angle of a surface at which a drop of a liquid disposed on the surface starts to roll.

As used herein, the term “spray” refers to an atomized spray or mist of a molten solid, a liquid solution, or a solid particle suspension.

As used herein, the term “complexity” is equal to (r−1)×100% where r is the Wenzel roughness.

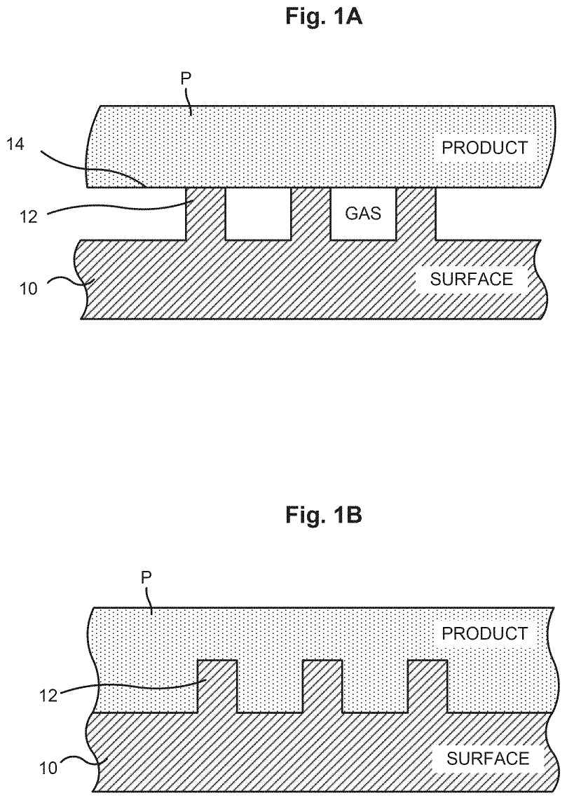

Referring now to FIGS. 1A and 1B, a conventional non-wetting surface 10 is a textured surface such that the non-wetting surface 10 includes a plurality of solid features 12 disposed on the surface 10. The solid features 12 define interstitial regions between each of the plurality of solid features which are impregnated by a gas, for example, air. A product P (e.g., a non-Newtonian fluid, a Bingham fluid, or a thixotropic fluid) is disposed on the conventional non-wetting surface such that the product contacts a top portion of the solid features but a gas-product interface 14 prevents the product from wetting the entire surface 10. In some cases, the product P can displace the impregnating gas and become impaled within the features 12 of the surface 10. Impalement may occur, for example, when a droplet of the product P impinges the surface 10 at high velocity. When impalement occurs, the gas occupying the regions between the solid features 12 is replaced with the product P, either partially or completely, and the surface 10 may lose its non-wetting capabilities.

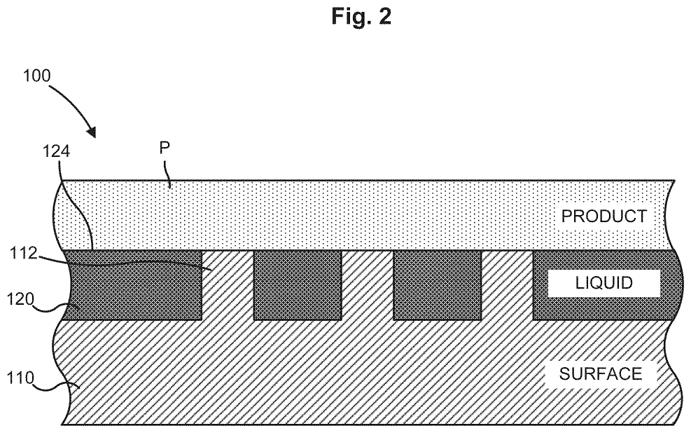

Referring now to FIG. 2, in some embodiments a liquid-impregnated surface 100 includes a solid surface 110 that includes a plurality of solid features 112 disposed on the surface 110 such that the plurality of solid features 112 define interstitial regions between the plurality of solid features. An impregnating liquid 120 is impregnated into the interstitial regions defined by the plurality of solid features 112. A product P is disposed on the liquid-impregnated surface 100 such that a liquid-product interface 124 separates the product from the surface 110 and prevents the product P from entirely wetting the surface 110.

The product P can be any product, for example, a non-Newtonian fluid, a Bingham fluid, a thixotropic fluid, a high viscosity fluid, a high zero shear rate viscosity fluid (shear-thinning fluid), a shear-thickening fluid, and a fluid with high surface tension and can include, for example a food product, a drug, a health and/or beauty product, any other product described herein or a combination thereof.

The surface 110 can be any surface that has a first roll off angle, for example a roll off angle of a product in contact with the surface 110 (e.g., water, food products, drugs, health or beauty products, or any other products described herein). The surface 110 can be a flat surface, for example, silicon wafer, a glass wafer, a table top, a wall, a wind shield, a ski goggle screen, or can be a contoured surface, for example a container, a propeller, a pipe, etc.

In some embodiments, the surface 110 can include an interior surface of a container for housing the product P (e.g., a food product, an FDA approved drug, and/or a health or beauty product) and can include, for example, tubes, bottles, vials, flasks, molds, jars, tubs, cups, glasses, pitchers, barrels, bins, totes, tanks, kegs, tubs, syringes, tins, pouches, lined boxes, hoses, cylinders, and cans. The container can be constructed in almost any desirable shape. In some embodiments, the surface 110 can include an interior surface of hoses, piping, conduit, nozzles, syringe needles, dispensing tips, lids, pumps, and other surfaces for containing, transporting, or dispensing the product P. The surface 110, for example the interior surface of a container can be constructed of any suitable material including plastic, glass, metal, coated fibers, and combinations thereof. Suitable surfaces can include, for example, polystyrene, nylon, polypropylene, wax, polyethylene terephthalate, polypropylene, polyethylene, polyurethane, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxytetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), polychlorotetrafluoroethylene (PCTFE), polyvinyl alcohol (PVA), polyethyleneglycol (PEG), polyfluoropolyether (PFPE), poly(acrylic acid), poly(propylene oxide), D-sorbitol, Tecnoflon cellulose acetate, fluoroPOSS, and polycarbonate. The container can be constructed of rigid or flexible materials. Foil-lined or polymer-lined cardboard or paper boxes can also form suitable containers. In some embodiments, the surface can be solid, smooth, textured, rough, or porous.

The surface 110 can be an inner surface of a container and can have a first roll off angle, for example, a roll off angle of a contact liquid CL (for example, laundry detergent, or any other contact liquid described herein). The surface 110 can be a flat surface, for example an inner surface of a prismatic container, or a contoured surface, for example an inner surface, of a circular, oblong, elliptical, oval or otherwise contoured container.

A plurality of solid features 112 are disposed on the surface 110, such that the plurality of solid features 112 define interstitial regions between the plurality of solid features 112. In some embodiments, the solid features 112 can be posts, spheres, micro/nano needles, nanograss, pores, cavities, interconnected pores, inter connected cavities, any other random geometry that provides a micro and/or nano surface roughness. In some embodiments, the height of features can be about 10 μm, 20 μm, 30 μm, 40 μm, 50 μm, 60 μm, 70 μm, 80 μm, 90 μm, or about 100 μm, 200 μm, 300 μm, 400 μm, 500 μm, 600 μm, 700 μm, 800 μm, 900 μm, up to about 1 mm, inclusive of all ranges therebetween, or any other suitable height for receiving the impregnating liquid 120. For example, in some embodiments, the solid features 112 can have a height of about 1 nm, 5 nm, 10 nm, 20 nm, 30 nm 40 nm, 50 nm, 100 nm, 200 nm, 300 nm, 400 nm, 500 nm, 600 nm, 700 nm, 800 nm, 900 nm, or about 1,000 nm, inclusive of all ranges therebetween. In some embodiments, the height of the features can be less than about 1 μm. Furthermore, the height of solid features 112 can be, for example, substantially uniform. In some embodiments, the solid features can have a wenzel roughness “r” greater than about 1.01, 1.05, 1.1, 1.2, 1.3, 1.4, 1.5, 1.6, 1.7, 1.8, 1.9, 2.0, 2.5, 3, 5, or about 10. In some embodiments, the solid features 112 can have an interstitial spacing, for example, in the range of about 1 μm to about 100 μm, or about 5 nm to about 1 μm. In some embodiments, the textured surface 110 can have hierarchical features, for example, micro-scale features that further include nano-scale features thereupon. In some embodiments, the surface 110 can be isotropic. In some embodiments, the surface 110 can be anisotropic.

The solid features 112 can be disposed on the surface 110 using any suitable method. For example, the solid features 112 can be disposed on the inside of a container (e.g., a bottle or other food container) or be integral to the surface itself (e.g., the textures of a polycarbonate bottle may be made of polycarbonate). In some embodiments, the solid features 112 may be formed of a collection or coating of particles including, but not limited to insoluble fibers (e.g., purified wood cellulose, micro-crystalline cellulose, and/or oat bran fiber), wax (e.g., carnauba wax, Japan wax, beeswax, rice bran wax, candelilla wax, fluorinated waxes, waxes containing silicon, waxes of esters of fatty acids, fatty acids, fatty acid alcohols, glycerides, etc), other polysaccharides, fructo-oligosaccharides, metal oxides, montan wax, lignite and peat, ozokerite, ceresins, bitumens, petrolatuns, paraffins, microcrystalline wax, lanolin, esters of metal or alkali, flour of coconut, almond, potato, wheat, pulp, zein, dextrin, cellulose ethers (e.g., Hydroxyethyl cellulose, Hydroxypropyl cellulose (HPC), Hydroxyethyl methyl cellulose, Hydroxypropyl methyl cellulose (HPMC), Ethyl hydroxyethyl cellulose), ferric oxide, ferrous oxide, silicas, clay minerals, bentonite, palygorskite, kaolinite, vermiculite, apatite, graphite, molybdenum disulfide, mica, boron nitride, sodium formate, sodium oleate, sodium palmitate, sodium sulfate, sodium alginate, agar, gelatin, pectin, gluten, starch alginate, carrageenan, whey and/or any other edible solid particles described herein or any combination thereof.

In some embodiments, surface energy of the surface 110 and/or the solid features 112 can be modified, for example, to enhance the adhesion of the solid features 112 to the surface 110 or to enhance the adhesion of the impregnating liquid 120 to the solid features 112 and/or the surface 110. Such surface modification processes can include, for example, sputter coating, silane treatment, fluoro-polymer treatment, anodization, passivation, chemical vapor deposition, physical vapor deposition, oxygen plasma treatment, electric arc treatment, thermal treatment, any other suitable surface chemistry modification process or combination thereof.

The solid features 112 can include micro-scale features such as, for example posts, spheres, nano-needles, pores, cavities, interconnected pores, grooves, ridges, interconnected cavities, or any other random geometry that provides a micro and/or nano surface roughness. In some embodiments, the solid features 112 can include particles that have micro-scale or nano-scale dimensions which can be randomly or uniformly dispersed on a surface. Characteristic spacing between the solid features 112 can be about 1 mm, about 900 μm, about 800 μm, about 700 μm, about 600 μm, about 500 μm, about 400, μm, about 300 μm, about 200 μm, about 100 μm, about 90 μm, about 80 μm, about 70 μm, about 60 μm, about 50 μm, about 40 μm, about 30 μm, about 20 μm, about 10 μm, about 5 μm, 1 μm, or 100 nm, about 90 nm, about 80 nm, about 70 nm, about 60 nm, about 50 nm, about 40 nm, about 30 nm, about 20 nm, about 10 nm, or about 5 nm. In some embodiments, characteristic spacing between the solid features 112 can be in the range of about 100 μm to about 100 nm, about 30 μm to about 1 μm, or about 10 μm to about 1 μm. In some embodiments, characteristic spacing between solid features 112 can be in the range of about 100 μm to about 80 μm, about 80 μm to about 50 μm, about 50 μm to about 30 μm, about 30 μm to about 10 μm, about 10 μm to about 1 μm, about 1 μm to about 90 nm, about 90 nm to about 70 nm, about 70 nm to about 50 nm, about 50 nm to about 30 nm, about 30 nm, to about 10 nm, or about 10 nm to about 5 nm, inclusive of all ranges therebetween.

In some embodiments, the solid features 112, for example solid particles can have an average dimension of about 200 μm, about 100 μm, about 90 μm, about 80 μm, about 70 μm, about 60 μm, about 50 μm, about 40 μm, about 30 μm, about 20 μm, about 10 μm, about 5 μm, 1 μm, about 100 nm, about 90 nm, about 80 nm, about 70 nm, about 60 nm, about 50 nm, about 40 nm, about 30 nm, about 20 nm, about 10 nm, or about 5 nm. In some embodiments, the average dimension of the solid features 112 can be in the range of about 100 μm to about 100 nm, about 30 μm to about 10 μm, or about 20 μm to about 1 μm. In some embodiments, the average dimension of the solid feature 112 can be in the range of about 100 μm to about 80 μm, about 80 μm to about 50 μm, about 50 μm to about 30 μm, or about 30 μm to about 10 μm, or 10 μm to about 1 μm, about 1 μm to about 90 nm, about 90 nm to about 70 nm, about 70 nm to about 50 nm, about 50 nm to about 30 nm, about 30 nm, to about 10 nm, or about 10 nm to about 5 nm, inclusive of all ranges therebetween. In some embodiments, the height of the solid features 112 can be substantially uniform. In some embodiments, the surface 110 can have hierarchical features, for example micro-scale features that further include nano-scale features disposed thereupon.

In some embodiments, the solid features 112 (e.g., particles) can be porous. Characteristic pore size (e.g., pore widths or lengths) of particles can be about 5,000 nm, about 3,000 nm, about 2,000 nm, about 1,000 nm, about 500 nm, about 400 nm, about 300 nm, about 200 nm, about 100 nm, about 80 nm, about 50, or about 10 nm. In some embodiments, characteristic pore size can be in the range of about 200 nm to about 2 μm, or about 10 nm to about 1 μm inclusive of all ranges therebetween. Controlling the pore size, the length of pores, and the number of pores can allow for greater control of the impregnating liquid flow rates, product flow rates, and overall material yield.

The impregnating liquid 120 is disposed on the surface 110 such that the impregnating liquid 120 impregnates the interstitial regions defined by the plurality of solid features 112, for example, pores, cavities, or otherwise inter-feature spacing defined by the surface 110 such that no air remains in the interstitial regions. The interstitial regions can be dimensioned and configured such that capillary forces retain part of the impregnating liquid 120 in the interstitial regions. The impregnating liquid 120 disposed in the interstitial regions of the plurality of solid features 112 is configured to define a second roll off angle less than the first roll off angle (i.e., the roll off angle of the unmodified surface 110. In some embodiments, the impregnating liquid 120 can have a viscosity at room temperature of less than about 1,000 cP, for example about 50 cP, about 100 cP, about 150 cP, about 200 cP, about 300 cP, about 400 cP, about 500 cP, about 600 cP, about 700 cP, about 800 cP, about 900 cP, or about 1,000 cP, inclusive of all ranges therebetween. In some embodiments, the impregnating liquid 120 can have viscosity of less than about 1 cP, for example, about 0.1 cP, 0.2 cP, 0.3 cP, 0.4 cP, 0.5 cP, 0.6 cP, 0.7 cP, 0.8 cP, 0.9 cP, or about 0.99 cP, inclusive of all ranges therebetween. In some embodiments, the impregnating liquid 120 can fill the interstitial regions defined by the solid features 112 such that the impregnating liquid 120 forms a layer of at least about 5 nm thick above the plurality of solid features 112 disposed on the surface 110. In some embodiments, the impregnating liquid 120 forms a layer of at least about 1 μm above the plurality of solid features 112 disposed on the surface 110. In some embodiments the plurality of solid features can have an average roughness, Ra, less than 0.8 μm, for example, in compliance with the rules and regulations of a regulatory body (e.g., the Food and Drug Administration (FDA)).

The impregnating liquid 120 may be disposed in the interstitial spaces defined by the solid features 112 using any suitable means. For example, the impregnating liquid 120 can be sprayed or brushed onto the textured surface 110 (e.g., a texture on an inner surface of a bottle). In some embodiments, the impregnating liquid 120 can be applied to the textured surface 110 by filling or partially filling a container that includes the textured surface 110. The excess impregnating liquid 120 is then removed from the container. In some embodiments, the excess impregnating liquid 120 can be removed by adding a wash liquid (e.g., water) to the container to collect or extract the excess impregnating liquid from the container. In some embodiments, the excess impregnating liquid may be mechanically removed (e.g., pushed off the surface with a solid object or fluid), absorbed off of the surface 110 using another porous material, or removed via gravity or centrifugal forces. In some embodiments, the impregnating liquid 120 can be disposed by spinning the surface 110 (e.g., a container) in contact with the liquid (e.g., a spin coating process), and condensing the impregnating liquid 120 onto the surface 110. In some embodiments, the impregnating liquid 120 is applied by depositing a solution with the impregnating liquid and one or more volatile liquids (e.g., via any of the previously described methods) and evaporating away the one or more volatile liquids.

In some embodiments, the impregnating liquid 120 can be applied using a spreading liquid that spreads or pushes the impregnating liquid along the surface 110. For example, the impregnating liquid 120 (e.g., ethyl oleate) and spreading liquid (e.g., water) may be combined in a container and agitated or stirred. The fluid flow within the container may distribute the impregnating liquid 120 around the container as it impregnates the solid features 112. In some embodiments, the impregnating liquid can be spray coated on the textured surface.

In some embodiments, the impregnating liquid 120 can include, silicone oil, a perfluorocarbon liquid, halogenated vacuum oil, greases, lubricants, (such as Krytox 1506 or Fromblin 06/6), a fluorinated coolant (e.g., perfluoro-tripentylamine sold as FC-70, manufactured by 3M), an ionic liquid, a fluorinated ionic liquid that is immiscible with water, a silicone oil comprising PDMS, a fluorinated silicone oil such as, for example polyfluorosiloxane, or polyorganosiloxanes, a liquid metal, a synthetic oil, a vegetable oil, an electro-rheological fluid, a magneto-rheological fluid, a ferrofluid, a dielectric liquid, a hydrocarbon liquid such as mineral oil, polyalphaolefins (PAO), or other synthetic hydrocarbon co-oligomers, a fluorocarbon liquid, for example, polyphenyl ether (PPE), perfluoropolyether (PFPE), or perfluoroalkanes, a refrigerant, a vacuum oil, a phase-change material, a semi-liquid, polyalkylene glycol, esters of saturated fatty and dibasic acids, polyurea, grease, synovial fluid, bodily fluid, or any other aqueous fluid or any other impregnating liquid described herein or any combination thereof.

The ratio of the solid features 112 (e.g., particles) to the impregnating liquid 120, can be configured to ensure that no portion of the solid features 112 protrude above the liquid-product interface. For example, in some embodiments, the ratio can be less than about 15%, or less than about 5%. In some embodiments, the ratio can be less than about 50%, about 45%, about 40%, about 35%, about 30%, about 25%, about 20%, about 15%, about 10%, about 5%, or less than about 2%. In some embodiments, the ratio can be in the range of about 5% to about 50%, about 10% to about 30%, or about 15% to about 20%, inclusive of all ranges therebetween. In some embodiments, a low ratio can be achieved using surface textures that are substantially pointed, caved, or are rounded. By contrast, surface textures that are flat may result in higher ratios, with too much solid material exposed at the surface.

In some embodiments, the liquid-impregnated surface 100 can have an “emerged area fraction” ϕ, which is defined as a representative fraction of the non-submerged solid corresponding to the projected surface area of the liquid-impregnated surface 100 at room temperature, of less than about 0.30, about 0.25, about 0.20, about 0.15, about 0.10, about 0.05, about 0.01, or less than about 0.005. In some embodiments, ϕ can be greater than about 0.001, about 0.005, about 0.01, about 0.05, about 0.10, about 0.15, or greater than about 0.20. In some embodiments, ϕ can be in the range of about 0 to about 0.25. In some embodiments, ϕ can be in the range of about 0 to about 0.01. In some embodiments, can be in the range of about 0.001 to about 0.25. In some embodiments, ϕ can be in the range of about 0.001 to about 0.10.

In some embodiments, liquid-impregnated surface 100 can have advantageous droplet roll-off properties that minimize the accumulation of the contacting liquid CL on the surfaces. Without being bound to any particular theory, in some embodiments, a roll-off angle which is the angle of inclination of the liquid-impregnated surface 100 at which a droplet of contact liquid placed on the textured solid begins to move, can be less than about 50°, less than about 40°, less than about 30°, less than about 25°, or less than about 20° for a specific volume of contact liquid. In such embodiments, the roll off angle can vary with the volume of the contact liquid included in the droplet, but for a specific volume of the contact liquid, the roll off angle remains substantially the same.

In some embodiments, the impregnating liquid 120 can include one or more additives to prevent or reduce evaporation of the impregnating liquid 120. For example, a surfactant can be added to the impregnating liquid 120. The surfactants can include, but are not limited to, docosenoic acid, trans-13-docosenoic acid, cis-13-docosenoic acid, nonylphenoxy tri(ethyleneoxy) ethanol, methyl 12-hydroxyoctadecanate, 1-Tetracosanol, fluorochemical “L-1006”, and any combination thereof. Examples of surfactants described herein and other surfactants which can be included in the impregnating liquid can be found in White, I., “Effect of Surfactants on the Evaporation of Water Close to 100 C.” Industrial &Engineering Chemistry Fundamentals 15.1 (1976): 53-59, the content of which is incorporated herein by reference in its entirety. In some embodiments, the additives can include C₁₆H₃₃COOH, C₁₇H₃₃COOH, C₁₈H₃₃COOH, C₁₉H₃₃COOH, C₁₄H₂₉OH, C₁₆H₃₃OH, C₁₈H₃₇OH, C₂₀H₄₁OH, C₂₂H₄₅OH, C₁₇H₃₅COOCH₃, C₁₅H₃₁COOC₂H₅, C₁₆H₃₃OC₂H₄OH, C₁₈H₃₇OC₂H₄OH, C₂₀H₄₁OC₂H₄OH, C₂₂H₄₅OC₂H₄OH, Sodium docosyl sulfate (SDS), poly(vinyl stearate), Poly (octadecyl acrylate), Poly(octadecyl methacrylate) and any combination thereof. Further examples of additives can be found in Barnes, G. T., “The potential for monolayers to reduce the evaporation of water from large water storages”, Agricultural Water Management 95.4 (2008): 339-353, the content of which is hereby by incorporated herein by reference in its entirety.

The liquid-impregnated surface 100 that is in contact with the contact liquid CL defines four distinct phases: an impregnating liquid 120, a surrounding gas (e.g., air), the contact liquid CL and the surface 110 with the solid features 112 disposed thereon. The interactions between the different phases determines the morphology of the contact line (i.e., the contact line that defines the contact angle of a contact liquid droplet with the liquid-impregnated surface) because the contact line morphology substantially impacts the droplet pinning and therefore contact liquid CL mobility on the surface. Details of such interactions and their impact on displacement of a contact liquid in contact with a liquid-impregnated surface are described in the '030 publication incorporated by reference above.

### Spray Coating Processes for Forming Liquid-Impregnated Surfaces

In some embodiments, the liquid-impregnated surface 100 can be formed using a spray coating process. For example, the solid features 112 and/or the impregnating liquid 120 can be deposited on the surface 110 using a spray process. The spray coating process can be controlled such that a desired texture, surface roughness, optical clarity, size of solid-particles, inter-particles spacing, and/or thickness of the liquid-impregnating surface 100 can be achieved. The solid particles that form the solid features 112 and/or the impregnating liquid 120 can be spray coated using any sprayer, for example, a SpriMag™ sprayer, an air sprayer, an ultra-sonic spray coater, a thermal spray coater, a plasma spray coater, an electric arc spray coater, or any other suitable spray coater. The solid particles can include any of the solid particles described herein. In some embodiments, the solid particles can be dissolved in a solvent or a carrier to form a solution suitable for spray coating. In some embodiments, the solid particles can be suspended in a suitable solvent and/or the impregnating liquid 120 to form a solid suspension which can be spray coated on the surface 110. In some embodiments, the solid particles can be melted, such that the particles can be directly spray coated on the surface 100 in molten form.

In some embodiments, the solid suspension or solid particles can be mixed with one or more impregnating liquids to form a new solid particle solution. In such embodiments, solvent concentration in the new solid particle solution (weight by weight) can be about 0%, about 1%, about 2%, about 3%, about 4%, about 5%, about 6%, about 7%, about 8%, about 9%, about 10%, about 20%, about 30%, about 40%, about 50%, about 60%, about 70%, about 80%, about 90%, or about 99%. In some embodiments, the solvent concentration in the new particle solution is in the range of about 50% to about 99.9%. In some embodiments, the solvent concentration in the new particle solution is in the range of about 0% to about 50% (i.e., less than about 50%). In some embodiments, the solid particles can have an average dimension of about 200 μm, about 100 μm, about 90 μm, about 80 μm, about 70 μm, about 60 μm, about 50 μm, about 40 μm, about 30 μm, about 20 μm, about 10 μm, about 5 μm, about 1 μm, about 100 nm, about 90 nm, about 80 nm, about 70 nm, about 60 nm, about 50 nm, about 40 nm, about 30 nm, about 20 nm, about 10 nm, or about 5 nm. The solid particles can be a combination of various average sized particles mentioned above. The particles size distribution can be controlled to obtain a desired solid texture or surface roughness.

In some embodiments, the solid particle solution with impregnated liquid can be spray coated onto the surface 110 to form the liquid impregnated surface 100 using any sprayer, for example a SpriMag™ sprayer, an air sprayer, an air-less sprayer, an ultra-sonic spray coater, a thermal spray coater, a plasma spray coater, an electric arc spray coater, a powder spray coater or any other suitable spray coater. The solid and impregnating liquid can include any of the chemicals described herein. The solid particle suspension with impregnating liquid can include one or more additives to stabilize solid particles in the liquid medium. For example, a surfactant can be added the solution. The surfactants can include, but not limited to oleic acid, elaidic acid, vaccenic acid, linoleic acid, caprylic acid, capric acid, lauric acid, myristic acid, palmitic acid, stearic acid, arachidic acid, bees wax, docosenoic acid, trans-13-docosenoic acid, cis-13-docosenoic acid, nonylphenoxy tri(ethyleneoxy) ethanol, a fluorochemical, and any combination thereof.

In some embodiments, surface 110 is roughened (i.e., to form a “roughened” or “pre-textured” surface comprising “irregularities” or surface “features”) and subsequently spray-coated with an impregnating liquid. The roughened surface can be formed by a roughening process that includes one or more of the following (by way of non-limiting example): applying one or more textured films, polymers, and/or plastics thereon; chemically etching the surface 110 (e.g., by contacting the surface with a liquid chemical such as an acid or a base, or by plasma etching); mechanically etching the surface 110 (e.g., via sand blasting, micro-blasting or dry ice blasting); pre-texturization by injection molding; blow molding; or by roughening using any other suitable process. The roughening process(es) imparts a roughness or “texture” to the surface that can have a characteristic average roughness (e.g., in units of microns or microinches), for example representing an arithmetic average of a height of roughness irregularities above a mean line along a sampling length. In some embodiments, an impregnating liquid subsequently applied to the roughened surface can be substantially conformal with the texture (e.g., having a substantially uniform thickness with respect to the roughened, along its contours). In other embodiments, an impregnating liquid subsequently applied to the roughened surface fills spaces between the irregularities or surface features, where the spaces may be of varying depth and/or volume, and may only thinly coat, or not coat at all, the tops of the irregularities or surface features, thereby exhibiting a substantially smooth (non-rough) top surface. In some embodiments, the surface chemistry of the pre-textured substrate can be changed or modified by different processes in order to form a stable liquid-impregnated surface. These methods include, but are not limited, to chemical vapor deposition, physical vapor deposition, spin coating, dip coating, sputter coating, etc.

In some embodiments, multiple spray coats of the solid particles, which can include any of the solid particles described herein, can be deposited on the surface 110 to control the texture, roughness, and/or thickness of the solid features 112 formed thereon. For example, in some embodiments, a single spray coat can be sufficient to obtain the desired surface texture. In other embodiments, 2 spray coats, 3 spray coats, 4 spray coats, 5 spray coats, or even more can be deposited on the surface 110 to obtain the desired texture of the solid features 112. Multiple sprays of a solid particles can improve the surface roughness and complexity of the texture formed on the surface 110. For example, the solid particles can be dissolved or suspended in a solvent to form a solid particle solution or suspension which can be spray coated numerous times on the surface 110. Each spray can dispense a predetermined amount of solid particles and solvent onto the surface 110. As the solvent evaporates, the solid particles in the solid particle solution can precipitate onto the surface 110 in a random orientation to form the solid features 112. A second spray can be deposited once the first spray has dried. Said another way, multiple spray coats can be deposited on the surface 110 by alternating spraying and drying cycles. In some embodiments, the drying cycle can be performed at ambient temperature and pressure. In some embodiments, the drying cycle can be accelerated by forcing a stream of inert gas (e.g., nitrogen) over the coated surface 110, by heating, and/or by any other suitable means. In some embodiments, a continuous cycle of spraying and drying can be performed by injecting air or any other inert gas to convectively evaporate the solvent while under continuous spray.

In some embodiments, the multiple spray coat process can be used to form hierarchical solid features 112 on the surface 110. For example, a first solid particle solution having solid particles in a first size range, for example, having a diameter in the range of about 10-20 μm, is first sprayed on the surface 110. A second solid particle solution having solid particles in a second size range substantially smaller than the first size range, for example, having a diameter in the range of about 1-5 μm, is sprayed on top of the first particle solution. Furthermore, a third solid particle solution having solid particles in a third size range substantially smaller than the second size range, for example, having a diameter in the range of about 0.1-0.3 μm, is sprayed on top of the second particle solution. In this manner, hierarchical solid features 112 can be formed on the surface 110 which can enhance surface roughness. In some embodiments, hierarchical solid features 112 can be formed on the surface 110 by spraying a polydisperse solution of the solid particles that include particles having various size ranges, on the solid surface 110. For example, the polydisperse solid particle solution can include first solid particles having a first size in the range of about 10-20 μm, second solid particles having a second size in the range of about 1-5 μm, and third solid particles having a third size in the range of about 0.1-0.3 μm. The polydisperse particles can all be formed from the same material, or can include solid particles of different materials. In some embodiments, the solid particles can include a texture, roughness, or porosity intrinsically, or such features can be defined on the particles before or after the spray coating process.

In some embodiments, the solid surface 110 can be textured by spraying a solvent on a solid particle coating. For example, a solution of solid particles can be spray coated on the surface 110 and allowed to solidify. A solvent can then be sprayed on the solid particle coating. The solvent can cause rapid dissolution of the solid particle coating, which then precipitates as the solvent evaporates and thereby, form the solid features 112. The chemistry and temperature of the solvent can be varied to impart the desired roughness to the solid particle coating. In some embodiments, the solvent can be sprayed on a pre-roughened surface 110 (i.e., a surface 110 which includes solid features 112 disposed thereon). This can, for example, increase or reduce the roughness of the surface 110. In some embodiments, the surface 110 that includes a solid particle coating disposed thereon, can be dipped or submerged in the solvent.

In some embodiments, the surface 110 can be roughened to create a micro or nano texture before spray coating a solid particle solution on the surface 110. The roughened surface 110 can include textured films, polymers, chemically etched surface, mechanically etched surface (e.g., sand blasted), or roughened using any other suitable process. In such embodiments, the solid particle solution can fill the texture of the roughened surface 110 to reduce roughness, or to build upon the inherent roughness of the surface 110 and enhance roughness.

The surface roughness and/or complexity of the textured surface 110 can be controlled by controlling the concentration of solid particles in a solids solution or suspension, for example, any of the solid particles described herein, dissolved or suspended in the solvent, the size and molecular weight of the particles, other physical conditions (e.g., spray pressure, atomizing air, spray velocity, spray time, etc.), and/or compositions of the solid particle solution. In this manner, geometrical properties of the surface texture can be controlled. Furthermore, such sprays can also reduce the formation of large agglomerates of solid particles on the surface 110 which can negatively impact the resulting liquid-impregnated surface. Therefore, in a multiple spray coat process, the concentration of solid particles or the size of the solid particles in each subsequent spray can be gradually decreased, thereby generating smaller scales of roughness while eliminating large agglomerates. Multiple spray coats of the same solution can generate a larger surface roughness which can be quantified by analyzing the complexity (which is related to the developed area i.e., the total surface area) over the projected area (i.e., the top view XY area). This large surface roughness can allow for higher capillary forces which, in effect, enhance the energy required to displace the impregnating liquid 120 from the textured surface 100. Furthermore, a higher quantity of impregnating liquid 120 can be trapped within the textured surface 110. In this manner, the liquid-impregnated surface 100 which includes a textured surface 110 formed using multiple spray coats can have higher stability and longer life.

In some embodiments, a gas sprayer (e.g., an air assisted sprayer) can be used to dispose a solid particle solution, suspension, or molten solid particles on a surface and the atomization gas pressure can be varied to increase the roughness of the textured surface 110. Altering the atomization gas pressure during the spray coating process can lead to greater solvent evaporation, enhanced roughness, and surface height uniformity of the solid features 112. It can also increase the height of the solid features 112, such that the solid features can trap a higher quantity of the impregnating liquid 120.

In some embodiments, the drying conditions for a spray coated solid particle formulation (e.g., a solution, a suspension, or molten solid particles) can be controlled to obtain a desired texture or surface roughness. For example, in some embodiments, the deposited solid particle (e.g., any of the solid particles described herein) coating can be dried under ambient conditions. In some embodiments, the deposited solid particle formulation can be dried at above ambient temperature (e.g., in an oven). For example, the solid particle coating can be dried at a temperature of greater than about 30 degrees Celsius, greater than about 40 degrees Celsius, greater than about 50 degrees Celsius, greater than about 60 degrees Celsius, greater than about 70 degrees Celsius, greater than about 80 degrees Celsius, greater than about 90 degrees Celsius, or even greater than about 100 degrees Celsius. In some embodiments, the solid particle coating can be dried using forced air or any other gas (e.g., nitrogen) which can be at ambient temperature or above ambient temperature (e.g., nitrogen in a convection oven). The drying process can, for example, be used to control the thickness of the solid features 112 formed on the surface 110, and the evaporation rate of the solvent, or carrier in which the solid particles are dissolved or suspended. In this manner, a uniform weight of the solid formulation is deposited on the surface 110. In some embodiments, the drying time can also be varied to control the surface roughness of the coating. Furthermore, the drying time can also be varied to improve the texture and/or roughness of the textured surface 110.

In some embodiments, the solid particle formulation (e.g., a solution or a suspension) can be heated before depositing on the surface 110. For example, in some embodiments, a solution of solid particles (e.g., any of the solid particles described herein) dissolved in a suitable solvent can be heated to a suitable temperature, for example, about 40 degrees Celsius, 50 degrees, Celsius, 60 degrees Celsius, 70 degrees Celsius, 75 degrees Celsius, 80 degrees Celsius, 85 degrees Celsius, 90 degrees Celsius, 95 degrees Celsius, 100 degrees Celsius or even higher, inclusive of all ranges therebetween, before spray coating on the surface 110. In some embodiments, pure solid particles can be melted at a high temperature, and the molten solid can then be spray coated on the surface 110.

In some embodiments, the solid particles that form the solid features 112 can be dissolved in the impregnating liquid 120 to form a solution. The solution can be in the form of a solid suspension or a liquid solution, which can be spray coated on the surface 110 to form the liquid-impregnated surface 100. In some embodiments, the solution of the solid particles (e.g., any of the solid particles described herein) dissolved in the impregnating liquid 120 (e.g., any of the impregnating liquids described herein) can be maintained at temperature above ambient temperature, for example, greater than about 50 degrees Celsius, greater than about 60 degrees Celsius, greater than about 70 degrees Celsius, greater than about 80 degrees Celsius, greater than about 90 degrees Celsius, or greater than about 100 degrees Celsius, to maintain the solution in liquid phase. In such embodiments, an external solvent might not be required but can be used to further alter a surface texture.

In some embodiments, a solid particle solution or suspension to be spray coated and the surface 110 can be maintained at different temperatures such to control the texture and/or roughness of the textured surface 112. For example, in some embodiments, the solid particle solution or suspension, which can include any of the solid particles described herein can be heated to a temperature above ambient, for example, about 50 degrees Celsius, 60 degrees Celsius, 70 degrees Celsius, 80 degrees Celsius, or even higher, inclusive of all ranges therebetween, and the surface 110 can be cooled, for example, to a temperature of 0 degrees Celsius. In some embodiments, the solid particle solution or suspension can be cooled and the surface 110 can be heated, for example, to a temperature of about 55 degrees Celsius, about 65 degrees Celsius, about 75 degrees Celsius, about 85 degrees Celsius, or about 95 degrees Celsius or any other suitable temperature. In some embodiments, the solid formulation spray can be at ambient temperature and the surface 110 can be heated, for example, to a temperature of about 55 degrees Celsius, about 65 degrees Celsius, about 75 degrees Celsius, about 85 degrees Celsius, or about 95 degrees Celsius or any other suitable temperature. The hot surface can, for example, melt the deposited solid particles on contact with the surface 110, which then resolidify. The resolidification can therefore allow the formation of a more uniform textured surface 112. In some embodiments, the solid formulation spray can be at an ambient temperature and the surface 110 can be cooled, for example, to a temperature of about 0 degrees Celsius, such that the solid particles can immediately solidify on contact with the cooled surface 110.

In some embodiments, a solid particle solution can include ultra violet (UV) active functional groups that can cross-link under UV light to form the solid features 112. Such compounds can include, for example, methacrylates (e.g., polymethyl methacrylate). In some embodiments, adhesion promoters can also be disposed on the surface 110 to promote adhesion of the solid features 112 to the surface 110. Suitable adhesion promoters can include, for example, silanes. For example, a vinyl triethoxy silane can be sprayed on the surface 110 and a methyl methacrylate can subsequently be sprayed on the surface to form a “polymer brush” on the surface 110. The surface 110 can then be exposed to UV radiation to urge the methyl methacrylate to cross-link and form the solid features 112. In some embodiments, the adhesion promoters can be coupled to micro or nanoparticles before disposition on the surface 110. For example, vinyl triethoxy silane can be appended to silicon oxide particles and sprayed on the surface 110 in the presence of a UV cross-linkable monomer (e.g., methyl methacrylate). The coating can then be exposed to UV light such that the monomers polymerize (e.g., form polymethyl methacrylate) and form a coating with the silicon oxide particles trapped therein.

In some embodiments, a solid particle solution can be stabilized by adding a surfactant, for example a fluorocarbon, to the solid particle solution prior to spray application. For example, the surfactant can be volatile which can evaporate after spray coating on the surface 110. Thus, the surfactant can only serve to stabilize the solid particle solution but is not part of the formed textured surface 110. Examples of suitable surfactants include SURFYNOL® 61, any other suitable surfactant or combination thereof.

In some embodiments, a solid particle solution or suspension can include a supercritical fluid. Supercritical fluids are fluids that are at a temperature and pressure above the critical point of the fluid where distinct solid and liquid phases do not exist. Supercritical fluids do not have any surface tension. Thus their properties can be tuned to the solid particles. Such supercritical fluids can act as a mass transfer carrier system and/or change the morphology of the solid features 112. For example, the solid features 112 can swell in the presence of the supercritical fluid. Supercritical fluids can be used in place of traditional solvents in a “solvent-free” spray process. Examples include supercritical carbon dioxide and supercritical water. Supercritical fluids can be used to synthesize, process, or spray solid particles, for example, polymer solid particles on the surface 110. The supercritical fluids can act as a transport mechanism to allow the polymer (e.g., di-block co-polymers, tri-block co-polymers, etc.) to create certain texture or roughness on the surface 110. The supercritical fluid can evaporate to produce thermodynamically stable solid features 112. Post-processing conditions, for example, washing away certain areas of the textured surface, can be used to produce posts, cavities, or features in a regular or irregular pattern.

In some embodiments, the solid particle solution can be formulated such that spray coating of the solid particle formulation on the surface 110 forms a ceramic sponge. For example, the spray of solid particles can include a polymer that can undergo non-solvent induced phase separation to form a sponge-like porous structure defining the solid features 112. For example, a solution of polysulfone, poly(vinylpyrrolidone), and DMAc may be spray coated onto the surface 110 and then immersed in a bath of water. Upon immersion in water, the solvent and non-solvent exchange, and the polysulfone precipitates and hardens.

In some embodiments, the solid particles can be comminuted to form a powder. The powder can then be directly coated on the surface 110 without dissolving in a solvent. In such embodiments, no solvent is required to spray coat the solid on the surface 110 to form the solid features 112. Any suitable powder spray coating equipment can be used to spray coat the solid particles such as, for example, the M3™ Supersonic spray gun (Uniquecoat Technologies), the M2™ AC-HVAF spray gun (Uniquecoat Technologies), the ENCORE® XT manual powder spray system (Nordson), the ENCORE® HD automatic powder coating gun (Nordson), or any other powder spray coating gun. Compressed air or oxygen can be used to propel the powdered solid particles onto the surface 110. In some embodiments, the powder spray guns can also be used to form roughen the surface 110. Spraying powdered solid particles on the surface to form solid features offers several advantages such as, for example, provide highly uniform spray pattern, control over spray velocity to control coating properties, high spray rates, high deposition efficiency, lower operating costs, lower costs of deployment, and reduced clogging of the spray nozzles. In some embodiments, an adhesive or a solvent can be disposed on the surface 110 before disposing the solid powdered particles on the surface 110, for example, to allow the solid particles to adhere to the surface. In some embodiments, the adhesive or the solvent can be applied after the solid particles have been deposited on the surface 110, for example, to glue or coalesce the particles to each other. In some embodiments, the solid particles can be adhered using heating, annealing, and/or a chemical reaction.

In some embodiments, solid foam, or a foam forming material (e.g., polyurethane foam) can be spray coated on the surface 100 to form the solid features 112. The foam can solidify on the surface under ambient conditions, higher temperatures and/or air flow rates to form solid features 112 on the surface 110. In some embodiments, two or more precursors can be “co-sprayed” on the surface 110 which can, for example, react on the surface to form the foam. For example, a first reactant A and a second reactant B can be sprayed on the surface 110 to form a solid polyurethane foam. The first reactant A can include, for example methylene diphenyl diisocyanate and polymeric methylene diphenyl diisocyanate. The second reactant B can include, for example, a blend of polyols which can participate in the reaction to form the solid. The second reactant B can also include additives such as, for example, catalysts, blowing agents, flame retardants, and/or surfactants. The concentration of polyols and/or other additives, for example, the surfactants can be varied to control the porosity of the foam.

In some embodiments, two or more reactive materials can be spray coated (e.g., co-sprayed) on the surface 110 to form the solid features 112. For example, a first reactive material can be co-sprayed with a second reactive material on the surface 110. In some embodiments, the first reactive material can be spray coated on the surface 110, and subsequently the second reactive material can be spray coated on the first reactive material. The second reactive material can react with the first reactive material to produce a gas such that the coating becomes porous. In some embodiments the second reactive material can react with the first reactive material to produce temporary dangling bonds in the first reactive material, which can agglomerate to form the solid features as well as promote adhesion to the surface 110. Furthermore, the dangling bonds can also react with the impregnating liquid 120 such that at least a portion of the impregnating liquid 120 covalently bonds to the solid features 112, thereby creating a more stable liquid-impregnated surface.

In some embodiments, the solid features 112 can be formed on the surface 110 by spraying a stream of a solvent into a stream of a solid particle solution. This can cause substantially higher nucleation of the solid particles and can also make the suspension unstable so that the solid particles agglomerate as they arrive at the surface 110. In some embodiments, a hot and/or humid gas (e.g., air or nitrogen) can be incorporated into the solid particle spray and/or the solvent spray to enhance porosity. In some embodiments, a solid particle solution can be co-sprayed with a solvent in which the solid particles have low solubility. In such embodiments, the solid particle solution can mix with the solvent to form a mixture which has a lower solubility to the solid particles such that the solid particles precipitate and form solid features on the surface 110. In some embodiments, the lower solubility solvent can include the impregnating liquid 120 or a solution of the impregnating liquid 120.

In some embodiments, the surface 110 can be exposed to a corona or plasma to change a surface energy of the substrate, for example, make the surface 110 hydrophilic (e.g., to promote adhesion of the solid features 112 or impregnating liquid 120 to the surface 110). In some embodiments, the surface 110 which has the solid features 112 disposed thereon can be exposed to the corona or plasma to change a surface energy of the surface 110 and/or the solid features 112 (e.g., make the surface 110 and/or the solid features 112 hydrophilic). This can, for example, promote adhesion of the impregnating liquid 120 to the surface 110 and/or the solid features 112.

In some embodiments, the solid particle solution can be spray coated on the surface 110 in a vacuum, for example, a vacuum chamber to facilitate solvent evaporation and/or minimize contamination of the particles from the environment. Spray coating in a vacuum can also improve the surface texture, for example, produce a textured surface that has greater roughness and can include solid features 112 having uniform thickness. Furthermore, vacuum coating can also allow uniform deposition of the solid particle solution on irregular surfaces, for example, on the inner surface of an irregular shaped container.

In some embodiments, an adhesive can first be spray coated on the surface 110 before spray coating the surface 110 with the solid particle solution. The adhesive layer can also be spray coated on the surface 110. Suitable adhesive layers can include, for example, glue, cement, mucilage, polymers, silicone adhesive, silanes, any other suitable adhesive layer or combination thereof. The adhesive layer can promote adhesion of the solid particles on the surface 110 to form durable solid features 112.

Any suitable spray nozzles and/or delivery devices can be used to spray coat the surface 110 with the solid particles. In some embodiments, the spray coating system can include multiple nozzles, which can, for example, be oriented in different directions. Such an arrangement can allow complete coverage of the surface 110 (e.g., the side walls of a container) with the solid particle formulation. In some embodiments, nozzles with different spray distributions can be used, for example, to coat different portions of the surface 110 at different flow rates or volume of the solid particle spray, such that a uniform coating of the solid particles on the surface 110 is obtained. In some embodiments, the nozzles can have a diameter in the range of about 5 um to about 5 mm. In some embodiments, a spray coating system can include spinning nozzles, i.e. nozzles that rotate about a central axis. The nozzle can be rotated from a first position where the solid particle spray is deposited on a first portion of the surface 110, to a second position where the solid particle spray is deposited on a second portion of the surface 110. Continuous spray of the solid particles while spinning the nozzle can allow complete coverage of the surface 110, for example, a circular container. In some embodiments, a spray coating system can include a flexible nozzle, for example, a nozzle mounted at an end of flexible tubing. The flexible nozzle can, for example, be useful for coating containers that have odd shapes (e.g., non-circular shapes or hard to access portions). In some embodiments, a spray coating system can include a misting device, for example, a fogger that can create a mist of the solid particle formulation. In such embodiments, the surface 110 can simply be exposed to a diffuse mist of the solid particles for a predetermined amount of time to form the solid features 112 on the surface 110.

In some embodiments, a spray coating system can include an airless spray technology. For example, the spray coating system can include an electrostatic spray gun for spray coating the solid formulation. In some embodiment, a voltage difference can be applied between the nozzle and the surface 110. The solid particles included in the solid spray can be electrostatically or ionically charged to have an opposite electrostatic potential relative to the voltage of the surface 110. Thus the charged solid particle spray can be propelled towards the charged surface 110 without the need of an air pressure. Airless spray technology can offer several benefits such as, for example, improved uniformity of the size of the solid feature 112, improved roughness, better uniformity, and control of coating thickness.

In some embodiments, a spray coating system can include electrical or thermal spraying. For example, solid materials or solid particles can be melted and sprayed using a plasma spray, detonation spray, wire arc spray, flame spray, high velocity oxy-fuel coating spray, or any other suitable electric or thermal spraying system can be used to melt a solid material before spraying the molten material on the surface 110 to form the solid features 112. Such electric or thermal spraying systems can generate substantially high temperatures to melt the solid materials. For example, an arc discharge can generate a plasma jet that can have a temperature of greater than about 15,000 Kelvin. At such high temperatures, metals, for example, molybdenum can be melted and sprayed on the surface 110 to form the solid features 112.

In some embodiments, the solid particles can include magnetic particles in the solid particle formulation. In such embodiments, a magnetic field can be applied across the surface 110 to propel the solid particles spray towards the surface 110. Furthermore, the magnetic field can urge the solid particle spray to widen out to coat the surface, as the spray emerges from the spray coating system. In some embodiments, the spray coated solid particles can be locally heated to melt and resolidify the particles and thereby, control the texture and/or surface roughness of the textured surface 110.

In some embodiments, a spray coating technology for spraying solid particles and or the impregnating liquid 120 on the surface can include a piezo actuation based technology. In some embodiments, a spray coating technology can include an electrohydrodynamic spray coating technology. In some embodiments, a spray coating technology can include a layer by layer spray coating technology.

In some embodiments, a spray coated surface can be subjected to a quality control process for controlling a thickness and/or a roughness of the solid features 112. For example, optical and/or magnetic coating thickness gauges such as, for example, spectroscopic ellipsometer, a ferrous or non-ferrous coating thickness gauge can be used for quality control of the coating thickness.

In some embodiments, the surface 110 can be an inner surface of a container, for example, a bottle, a jug, a tube, a vial, a large tank, or any other container as described herein. In such embodiments, a rotating mechanism can be used to control rotation of the container such that a solid particle spray can be uniformly deposited on an inner surface of the container.

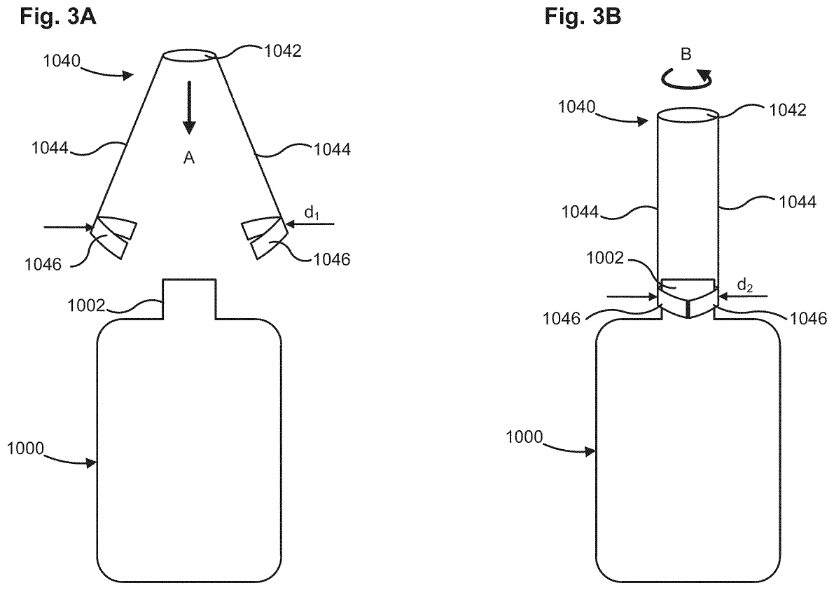

Referring now to FIGS. 3A and 3B, a rotating mechanism 1040 can be used to clamp a neck of a container 1000 and rotate the container 1000. The container includes a neck 1002 which has a substantially smaller diameter or otherwise cross-section than the body of the container 1000. The rotating mechanism 1040 includes a base 1042. The rotating mechanism 1040 further includes a set of arms 1044 (e.g., two arms). A proximal end of each of the set of arms 1044 is coupled to the base 1042. A clamp 1046 is coupled to a distal end of each of the arms 1044. Each clamp 1046 can, have a shape (e.g., a semi-circular shape) and size (e.g., radius of curvature) which corresponds to the diameter or otherwise cross-section of the neck 1002, such that the clamps 1046 can be contiguous with an outer surface of the neck 1002 in the second configuration, as described herein. In some embodiments, an inner surface of one or more of the clamps 1046 can include grooves, ridges, indentations, protrusions, projections, or any other features to facilitate gripping of an outer surface of the neck 1002 in the second configuration with substantial friction such that any slipping is reduced. In some embodiments, the inner surface of one or more of the clamps 1002 can include a soft material, for example, foam pad, rubber pad, silicon gel, adhesive, or any other soft and flexible material, to reduce any mechanical damage to neck 1002 caused by the clamps 1046 gripping the neck 1002. The arms 1044 are operable to articulate about the base 1042 from a first configuration where the clamps 1046 are at a first distance d₁ from each other, to a second configuration where the clamps 1046 are at a second distance d₂ from each other such that the second distance d₂ is smaller than the first distance d₁. The second distance d₂ can be configured to be substantially equal to a size, diameter, or otherwise cross-section of the neck 1002 of the container 1000 such that the clamps 1046 can secure the neck 1002 of the container 1000.

For example, as shown in the FIG. 3A, the rotating mechanism 1040 can be in the first configuration. The rotating mechanism 1042 can be moved towards the container 1000 in a direction shown by the arrow A until the clamps are in proximity of the neck 1002 of the container 1000. The rotating mechanism 1040 can then be urged into the second configuration (FIG. 3B) such that the distance d₂ is substantially similar to the outer diameter or other wise cross-section of the neck 1002 and the clamps 1046 secure the neck 1002. The rotating mechanism 1040 can now be rotated as shown by the arrow B to rotate the container 1000.

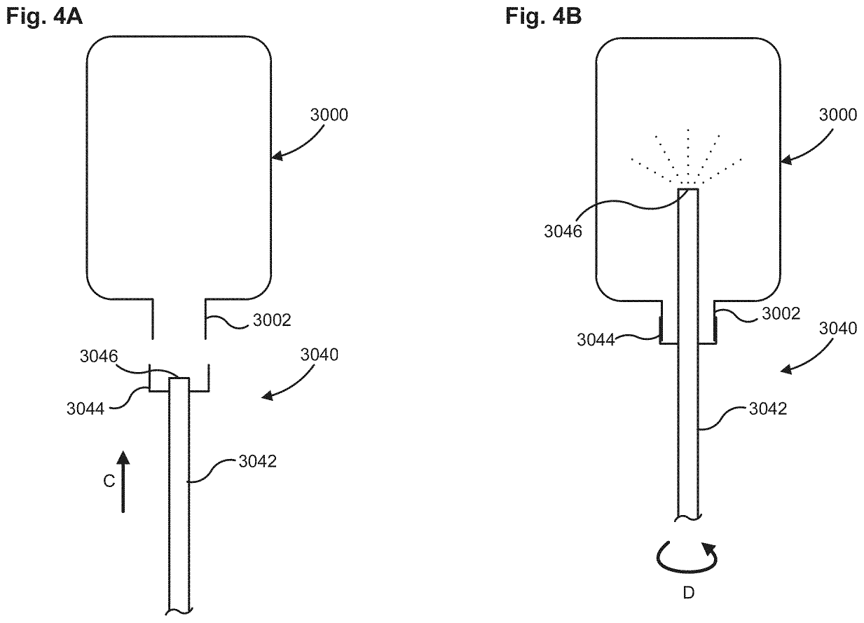

In some embodiments, a rotating mechanism can include a nozzle and a clamp. Referring now to FIGS. 4A and 4B, a rotating mechanism 3040 can include a conduit 3042, for example, a tube or a pipe. A nozzle 3046 is disposed at a distal end of the conduit 3042. A clamp 3044 can be disposed around the conduit 3042 which is configured to secure a neck 3002 of a container 3000. The container 3000 can be substantially similar to the container 1000, 2000, or any other container described herein. The conduit 3042 is operative to move within the clamp 3046. For example, in a first configuration FIG. 4A container 3000 can be upside down and the rotating mechanism 3040 can be disposed below the container 3000. The conduit 3042 can be urged to move towards the container 3000 as shown by the arrow C, such that in a second configuration, the clamp 3044 secures the neck 3002 of the container 3000 and at least a portion of the conduit 3042 is disposed within an internal volume defined by the container 3000. The conduit 3042 or the container 3000 can be rotated as shown by the arrow D (FIG. 4B) and a solid particle spray can be delivered by the nozzle 3046 onto the inner side walls of the container 3000 to form the textured surface.

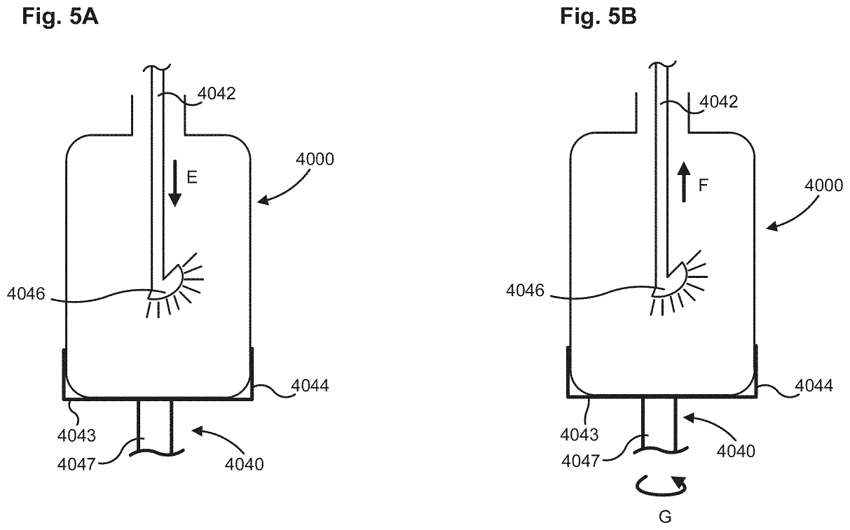

In some embodiments, a rotating mechanism can include a clamp for securing a side wall of a container. Referring now to FIGS. 5A and 5B, a rotating mechanism 4040 includes a pedestal 4043 on which a based of the container 4000 can be disposed. The container 4000 can be substantially similar to the container 1000, 2000, 3000, or any other containers described herein. Clamps 4044 are disposed on the edges of the pedestal 4043 which are operative to secure at least a portion of the side walls of the container 4000. In a first configuration, a conduit 4042 can be inserted into the inner volume of the container 4000 in the direction shown by the arrow E (FIG. 5A). A nozzle 4046 is disposed at a distal end of the conduit 4042. The nozzle 4046 is configured such that a solid particle spray communicated through the nozzle 4046 is spread over a wide angle, for example, to coat a large portion of the side walls of the container 4000. The pedestal 4043 can be coupled to a motor (not shown) by a rotor 4047. The rotor 4047 can rotate the pedestal 4043 as shown by the arrow G (FIG. 5B) which also urges the container 4000 to rotate. In this manner, the solid particles can be disposed on substantially all of the inner surface of the container 4000. Once the spray process is complete, the conduit 4042 can be withdrawn out of the inner volume of the container by displacing the conduit 4042 in the direction shown by the arrow F.

In some embodiments a rotating mechanism can include a rotating nozzle instead of a rotating container. For example, the nozzle shown in FIGS. 5A & 5B could be rotating as it moves in an out of the container. If the container has a non-circular cross-section (e.g., oval, elliptical, asymmetrical, etc.), then a constant flow rate through the nozzle would result in an uneven coating. Therefore, in some embodiments, the nozzle could be configured to have flow rate that varies as the container rotates, for example, higher flow rates when spray coating a more distant part of a sidewall of a container.

The following examples show textured surfaces with improved surface roughness formed via various embodiments of the spray coating processes described herein. Where complexity (higher complexity meaning greater roughness) was measured to show the efficacy of the spray coating process. Such textured surfaces can be used to form liquid-impregnated surfaces with higher stability and longer life. These examples are only for illustrative purposes and are not intended to limit the scope of the present disclosure.

### Example 1: Multiple Spray Coats to Improve Surface Roughness

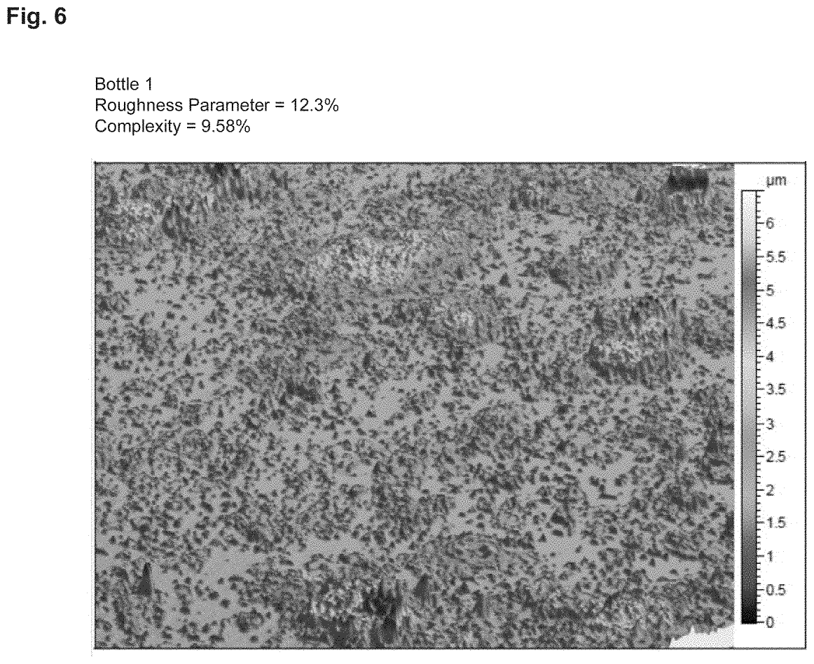

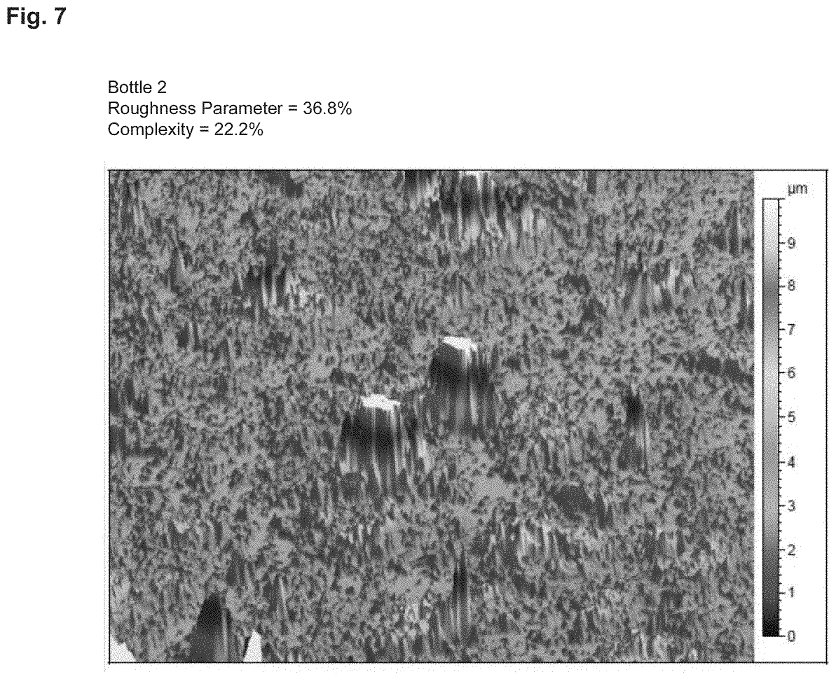

In this example, multiple spray coats were performed on the inner surface of a container to form a textured surface with improved surface roughness. First a solution of solid particles was prepared by dissolving 3% beeswax in ethyl acetate. A SpriMag™ spray coater was filled with the solid particle solution. The spray coater was calibrated to deliver substantially the same weight of the solid particle solution on spraying for a predetermined period of time, from a first spray to a second spray and so on. The solid particle solution was spray coated on a first 8 oz empty PET bottle (Bottle 1) and a second 8 oz empty PET bottle (Bottle 2), the bottle 1 substantially similar to the bottle 2. Before the spray coating, the weight of each of the uncoated bottle 1 and bottle 2 was measured. First, an inner surface of bottle 1 was coated for a first predetermined period of time with the solid particle solution and then dried in stream of nitrogen for about 20 seconds until ethyl acetate completely evaporated. The weight of the 1× coated bottle 1 which included a single coating was measured and determined to be about 0.04 grams. Next, an inner surface of the bottle 2 was coated with the same solid particle solution for a second predetermined time which was substantially similar to the first predetermined period of time. The spray coated bottle 2 was dried with a stream of nitrogen for about 20 seconds. The process was repeated 5 times to get 5 coats on the bottle 2 such that the weight of the 5× coated bottle 2 was about 0.20 grams, about five times the weight of the 1× coated bottle 1. The surface texture of the bottle 1 and bottle 2 was analyzed using an interferometer (Taylor Hobson, CCI HD) to determine the roughness parameters of the inner surfaces of two bottles. FIG. 6 shows, the interferometry image of the 1× coated surface of bottle 1, and FIG. 7, shows the interferometry image of the 5× coated surface of bottle 2. The 5× coated textured surface of bottle 2 had a roughness parameter of about 36.8% and a complexity of about 22.2%. In contrast, the single coated textured surface of bottle 1 had a roughness parameter of about 12.3% and complexity of about 9.6%, substantially lower than the multi coated textured surface of bottle 2.

### Example 2: Varying Pressures of Atomizing Air

In this example, textured surfaces were formed on an inner surface of containers by spraying a solid solution at varying pressures of atomizing air. A solution of solid particles was prepared by dissolving 3% beeswax in ethyl acetate. A SpriMag™ spray coater was filled with the solid particle solution. The spray coater was calibrated to deliver substantially the same weight of the solid particle solution on spraying for a predetermined period of time, from a first coat to a second coat and so on. An inner surface of six empty 8 oz PET bottles, bottle 1-1, bottle 1-2, bottle 2-1, bottle 2-2, bottle 3-1, and bottle 3-2 was spray coated with substantially the same weight of the solid particle solution. Bottles 1-1 and 1-2 were coated at an atomizing air pressure of 30 psi, bottles 2-1 and 2-2 were coated at an atomizing air pressure of 60 psi, and bottles 3-1 and 3-2 were coated at an atomizing air pressure of 90 psi. The bottles were dried in nitrogen for 20 seconds and the roughness parameter and complexity of the textured inner surface of each bottle was measured using interferometry imaging. The results are summarized in table 1.

TABLE 1

| | Atomizing Air | Roughness | |
|---|---|---|---|
| Bottle | Pressure | Parameter | Complexity |
| 1-1 | 30 psi | 12.3% | 9.5% |
| 1-2 | 30 psi | 10.5% | 8.3% |
| 2-1 | 60 psi | 15.1% | 11.3% |
| 2-2 | 60 psi | 14.1% | 10.8% |
| 3-1 | 90 psi | 15.7% | 12.9% |
| 3-2 | 90 psi | 16.3% | 13.8% |

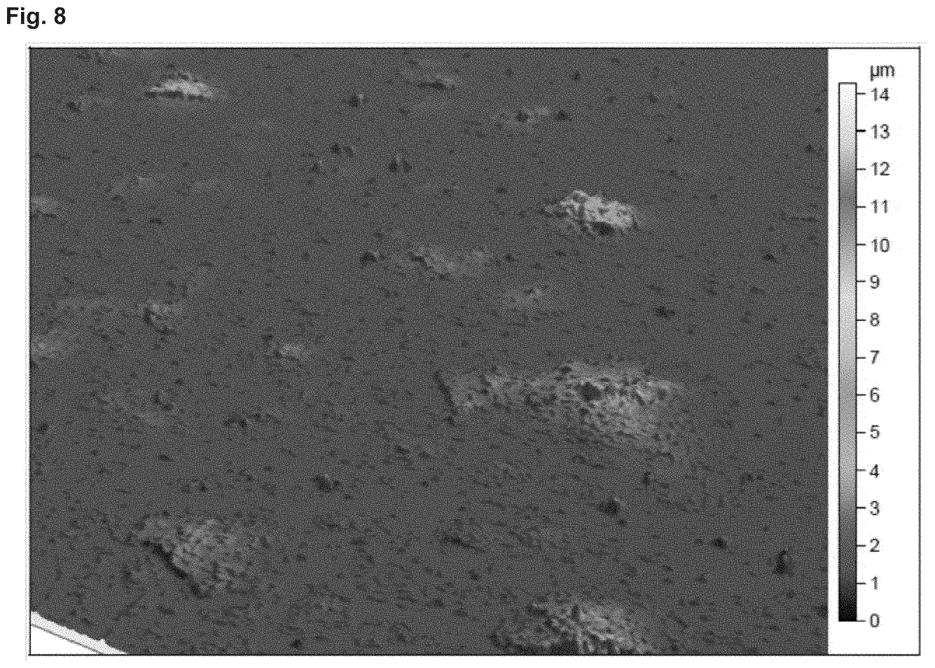

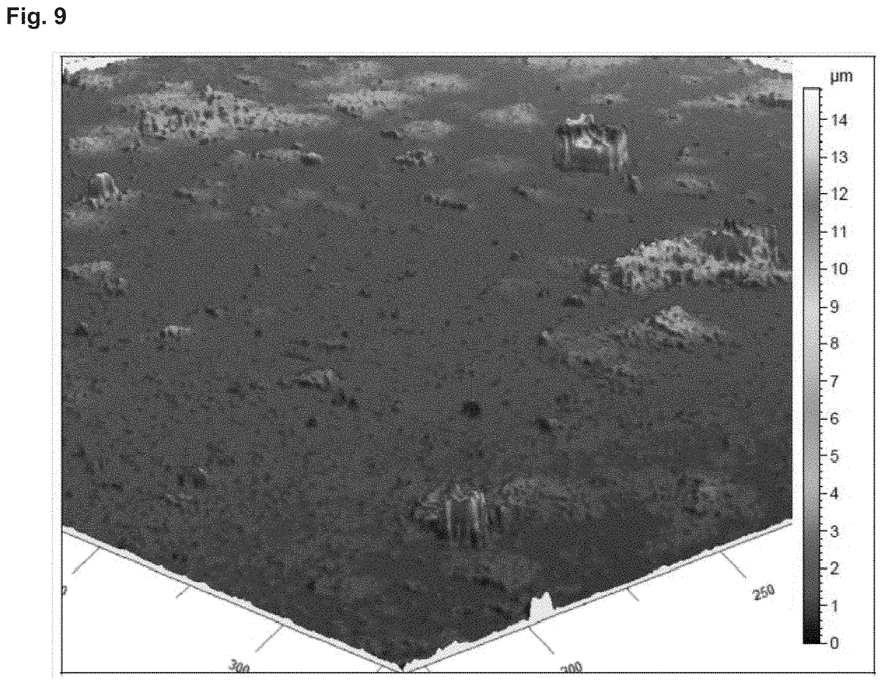

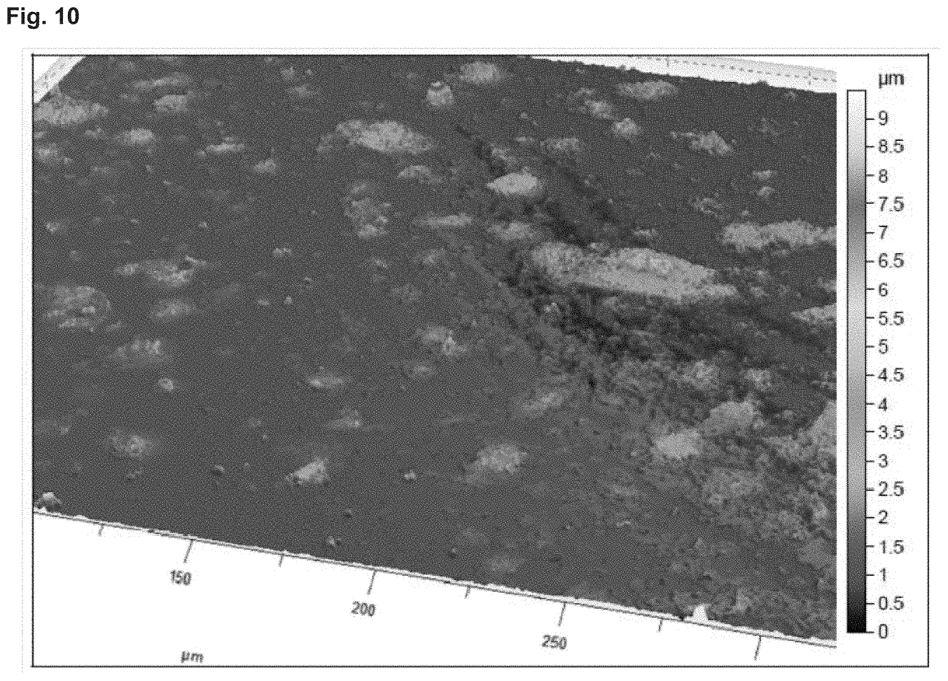

As can be seen from table 1, higher atomizing air pressures can result in textured surfaces having higher roughness parameter and complexity and thus higher stability. FIG. 8, FIG. 9, and FIG. 10 show interferometry images (Taylor Hobson, CCI HD) of the bottle 1-1 coated at 30 psi, bottle 2-1 coated at 60 psi, and bottle 3-1 coated at 90 psi, respectively. As can be seen, among these three bottles, the bottle 3-1 coated at 90 psi has the highest roughness, while the bottle 1-1 coated at 30 psi has the lowest roughness.

### Example 3: Varying Drying Conditions

In these experiments, solid particle solution was spray coated on inner surfaces of containers and the coated solid particle solution was dried under various conditions. The drying conditions included drying in ambient conditions, heating to a temperature of about 50 degrees Celsius, drying with forced nitrogen for a time of about 10 seconds, about 20 seconds, or about 30 seconds. A solution of solid particles was prepared by dissolving 3% beeswax in ethyl acetate. A SpriMag™ spray coater was filled with the solid particle solution. The spray coater was calibrated to deliver substantially the same weight of the solid particle solution on spraying for a predetermined period of time, from a first coat to a second coat and so on. The solid particle solution was spray coated on the inner surface of plurality of 8 oz PET bottles which were substantially similar to each other. Each bottle was weighed before coating the bottle. A set of five bottles were dried using each of the drying conditions as described below;

1) Five bottles were weighed immediately after spraying the solid particle solution and then dried in ambient conditions. The weight of each bottle was measured again at 20 minutes, 40 minutes, 60 minutes, 120 minutes, 180 minutes, and 240 minutes.

2) Five bottles were weighed immediately after spraying the solid particle solution and then placed in the oven at about 50 degrees Celsius. The weight of each bottle was measured again at 20 minutes, 40 minutes, 60 minutes, 120 minutes, 180 minutes, and 240 minutes.

3) Five bottles were dried with forced nitrogen for about 10 seconds and then weighed immediately after finishing the nitrogen spray. The bottles were then set at ambient conditions and the weight of each bottle was measured again at 20 minutes, 40 minutes, 60 minutes, 120 minutes, 180 minutes, and 240 minutes.

4) Five bottles were dried with forced nitrogen for about 20 seconds and then weighed immediately after finishing the nitrogen spray. The bottles were then set at ambient conditions and the weight of each bottle was measured again at 20 minutes, 40 minutes, 60 minutes, 120 minutes, 180 minutes, and 240 minutes.

5) Five bottles were dried with forced nitrogen for about 30 seconds and then weighed immediately after finishing the nitrogen spray. The bottles were then set at ambient conditions and the weight of each bottle was measured again at 20 minutes, 40 minutes, 60 minutes, 120 minutes, 180 minutes, and 240 minutes.

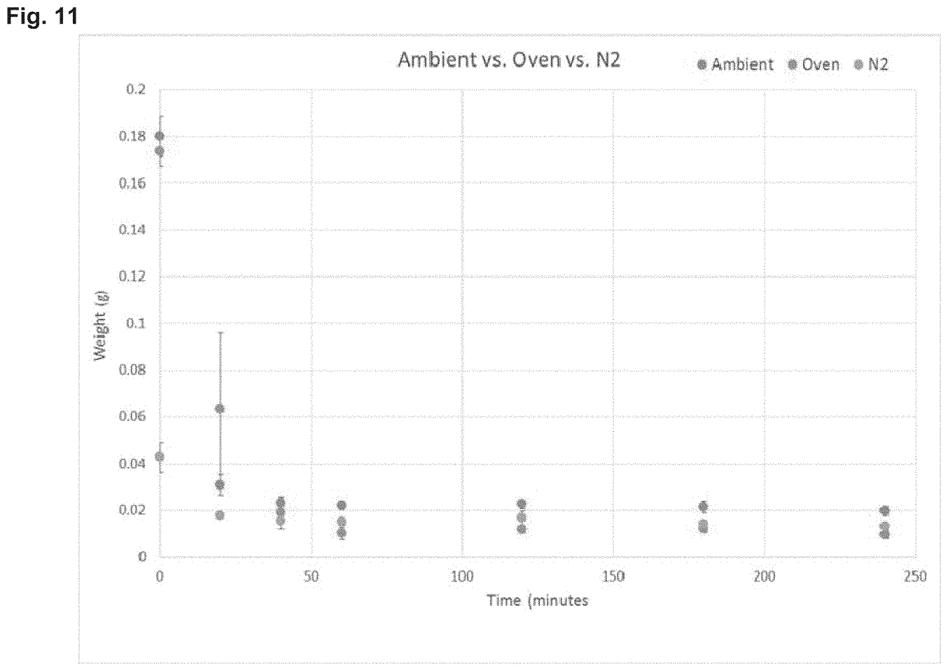

FIG. 11 shows the average weight of a set of five bottles dried at the ambient condition, in the oven maintained at 50 degrees Celsius, and with forced nitrogen at different time points. The results indicate that drying with forced nitrogen allowed the solvent in the solid particle solution coating to evaporate faster and the solid particle coating to reach a substantially constant coating weight in the shortest period of time. A stream of nitrogen delivered for 20 seconds significantly reduces the weight of the coated solid particle solution in the bottle due to rapid evaporation of solvent. The remaining coating weight is consistent with the amount of solid particles that are expected to adhere to the bottle. While the forced nitrogen used in these experiments was at ambient atmosphere, in some embodiments, a heated stream of nitrogen can also be used to enhance evaporation of the solvent, thereby speeding up the drying process.

### Example 4: Spray Coating a Heated Solid Particle Solution

In this example, the solid particle solution was heated before spray coating on inner surfaces of containers. Two different approaches were used; 1) a hot solid solution was spray coated using a preheated spray gun and; 2) a pure melted solid was sprayed using a spray gun, as described below

### 1. Hot Solid Particle Solution

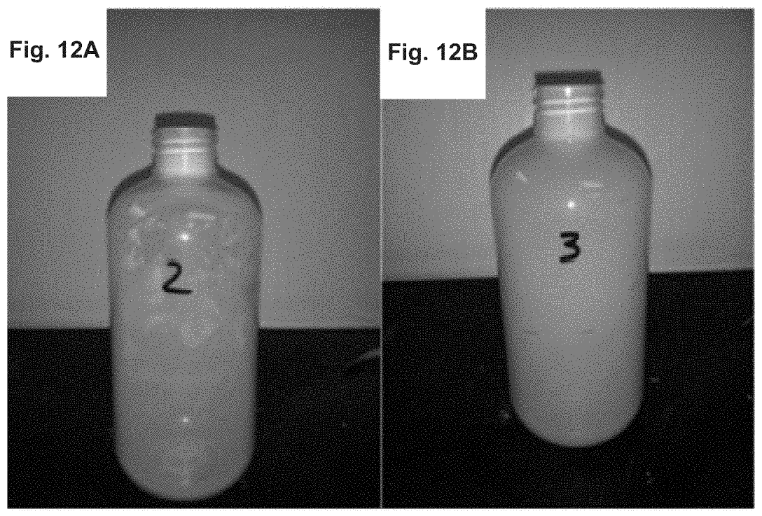

A solid particle solution of 3% beeswax was prepared by adding 1.5 grams of beeswax to 50 ml of ethyl acetate and heating and stirring the solution until 1.5 grams of the beeswax solid was completely dissolved. The solution was kept in a glass jar at about 75 degrees Celsius. A SpriMag™ spray coater was wrapped with aluminum foil and a thermocouple was disposed close to the nozzle of the spray coater to monitor the temperature. The spray gun was heated to about 75 degrees Celsius. An 8 oz empty plastic bottle was weighed prior to coating with the solid particle solution. The jar of the heated beeswax solid particle solution was fluidically coupled to the spray coater and the hot solid particle solution was spray coated on an inner surface of the bottle. Nitrogen was blown for 10 seconds over the solid particle coating to evaporate the residual solvent. The coated bottle was then weighed and the surface topography of the coated inner surface of the bottle was studied. Two substantially similar 8 oz PET bottles, bottle 2 and bottle 3 were coated with the solid particle solution as described above. Bottle 2 had a deposited weight of the solid particles of about 0.02 grams and Bottle 3 had a deposited weight of the solid particles of about 0.1 grams. FIGS. 12A and 12B show optical images bottle 2 and bottle 3 after coating with the heated solid particle solution.

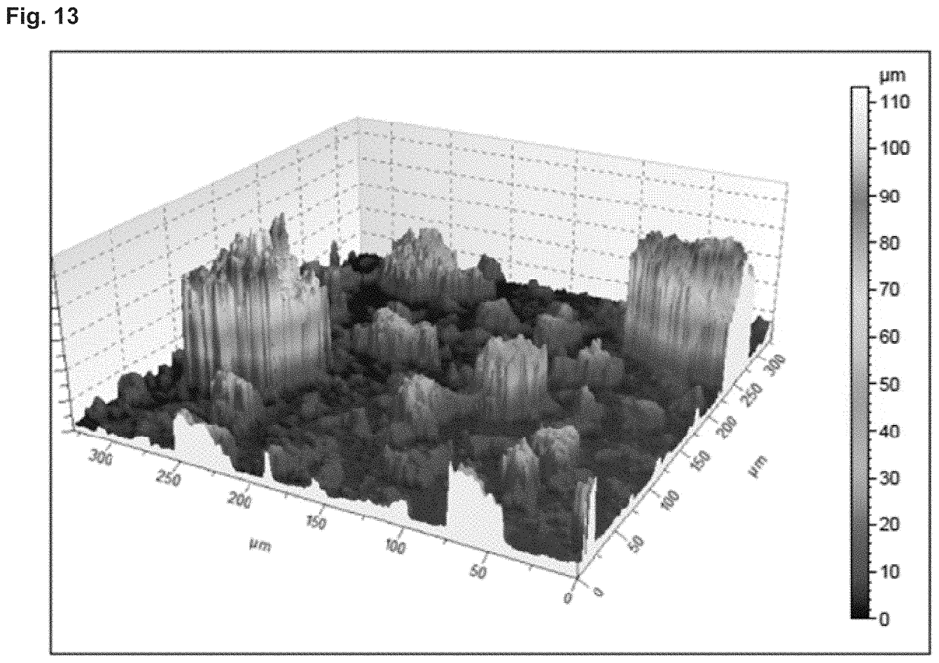

Bottle 3 was used to study the surface topography and coating thickness of the solid particle coating. The coating thickness was determined by scratching the coating to expose the underlying surface and measuring the step height using a profilometer. The thickness was taken as the step height between the average of part of the scratched area and an average of an area with the coating, which was determined to be about 1.3 μm. The surface topography was studied using interferometry (Taylor Hobson, CCI HD). The interferometry image is shown in FIG. 13. The root mean square (RMS) roughness was determined to be about 20.2 μm, and the complexity was about 175%.

Bottle 2 was testing for sliding properties of mayonnaise. An impregnating liquid propylene glycol dicaprate/dicaprylate was sprayed on the textured inner surface of the bottle to form a liquid-impregnated surface. The weight of the deposited impregnating liquid was determined to be about 0.4 grams. Mayonnaise was then disposed into the bottle. Good sliding performance of mayonnaise on the liquid-impregnated surface was observed. Furthermore, substantially no pinning was observed on the liquid-impregnated surface.

### 2. Pure Melted Solid

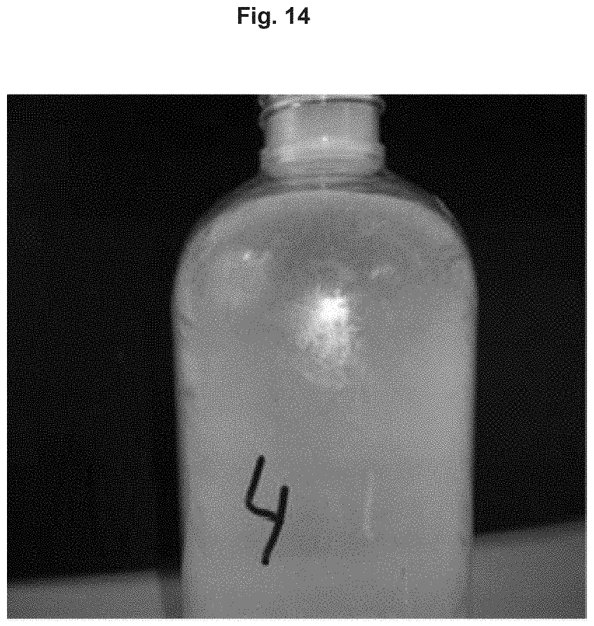

Ten grams of pure beeswax solid was heated until the solid was completely melted. The melted beeswax was kept warm in a glass jar at about 75 degrees Celsius. A SpriMag™ spray coater was wrapped with aluminum foil and a thermocouple was disposed close to the nozzle of the spray coater to monitor the temperature. The spray gun was heated to about 75 degrees Celsius. An 8 oz empty plastic bottle was weighed prior to coating with the solid. The jar of the heated beeswax was fluidically coupled to the spray coater and the molten beeswax was spray coated on an inner surface of the bottle. The coated bottle was then weighed and the surface topography of the coated inner surface of the bottle was studied using interferometry (Taylor Hobson, CCI RD). Two substantially similar 8 oz PET bottles, bottle 4 and bottle 5 were coated with the solid particle solution as described above. Bottle 4 had a deposited weight of about 0.04 grams and Bottle 5 had a deposited weight of about 0.05 grams. The deposited coating was homogenous as can be seen in the optical image of bottle 4 shown in FIG. 14. Bottle 4 was used to study the surface topography of the melted solid particle solution coating. Bottle 5 was used to study sliding performance.

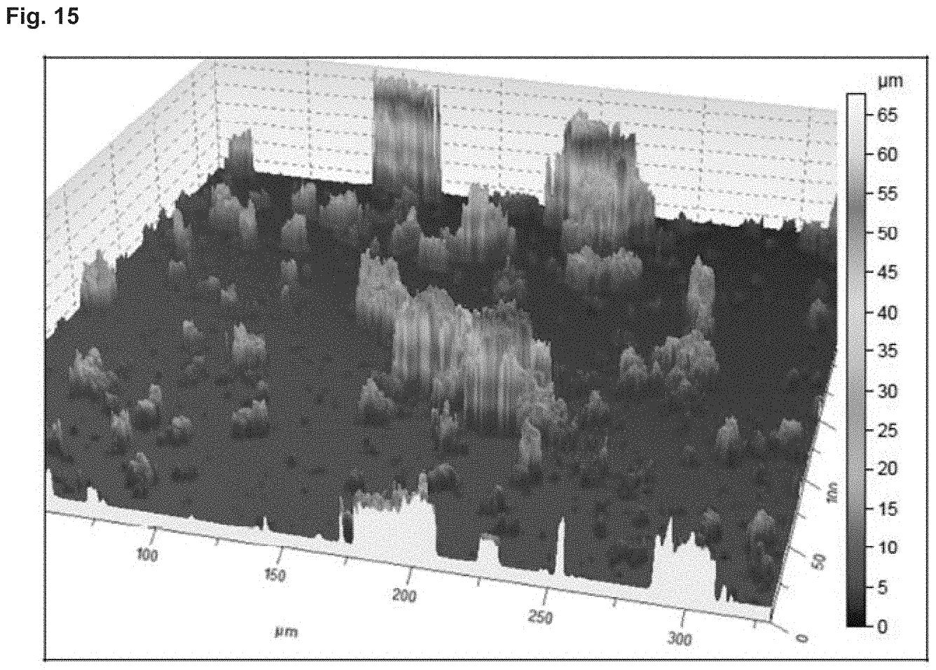

The surface topography was studies using interferometry (Taylor Hobson, CCI HD). The interferometry image is shown in FIG. 15. The root mean square (RMS) roughness was determined to be about 7.6 μm, and the complexity was about 102%.

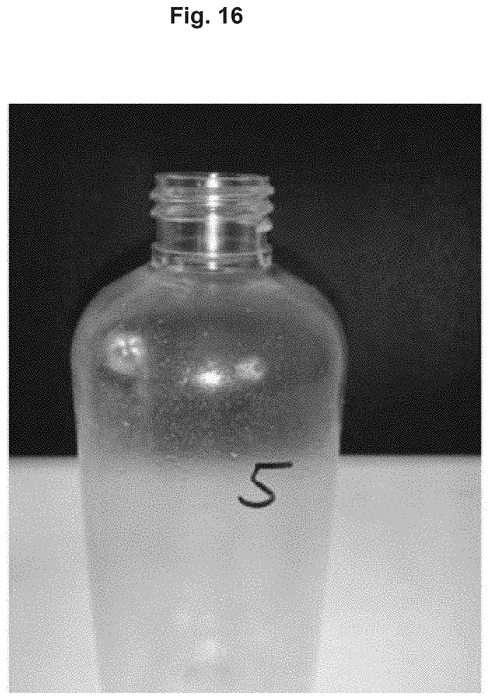

Bottle 5 was testing for sliding properties of mayonnaise. An impregnating liquid propylene glycol dicaprate/dicaprylate was sprayed on the textured inner surface of the bottle to form a liquid-impregnated surface. The weight of the deposited impregnating liquid was determined to be about 0.4 grams. FIG. 16 shows an optical image of the bottle 5 that includes the liquid-impregnated surface. Mayonnaise was then disposed into the bottle. Good sliding performance of mayonnaise on the liquid-impregnated surface was observed.

### Example 5: One Step Spray Including Solid Particles and Impregnating Liquid

In this example, a spray that includes solid particles dissolved or suspended in the impregnating liquid (i.e., the impregnating liquid acts as a solvent for the solid particles) was spray coated onto a surface such that a liquid-impregnated surface was formed in a one-step coating process. The solution of solid particles in the impregnating liquid solution was spray coated on a surface as a molten solution or a solid suspension. A solid particle solution of 5% carnauba wax in propylene glycol dicaprate/dicaprylate impregnating liquid was prepared by adding 2.5 grams of carnauba wax in 50 ml of propylene glycol dicaprate/dicaprylate. The solid particle solution was prepared by heating the propylene glycol dicaprate/dicaprylate impregnating liquid containing the carnauba wax solid to a temperature of greater than about 80 degrees Celsius until the carnauba wax solid dissolved such that the solution was transparent and yellowish in color. Then 25 ml of this solid particle solution was filled in a first SpriMag™ spray coater jar and cooled with cold water while being subjected to sonication in an ultrasonicator. As the solution cooled, solid particles of carnauba wax precipitated in to the impregnating liquid thereby forming a suspension of carnauba wax solid particles in the propylene glycol dicaprate/dicaprylate impregnating liquid.

The remaining 25 ml of the molten solid particle solution was filled in a second SpriMag™ spray coater jar and kept in the molten state by placing the spray coater on a hot plate maintained at a temperature of greater than about 80 degrees Celsius. The solid particle suspension was spray coated on the inner surface of two glass bottles, glass A and glass B, and a PET bottle PET A. Similarly, the molten solid particle solution was also spray coated on two glass bottles, glass C and glass D, and a PET bottle PET B, thereby forming a liquid-impregnating surface on the inner surface of each of the spray coated bottles. Each of the glass bottles and the PET bottles were weighed before coating and after coating with the solid particle solution to determine the weight of the deposited coating. The results are shown in table 2

TABLE 2

| | Weight of | Weight of | Weight of |
|---|---|---|---|
| | Bottle | Coated Bottle | Coating |
| Bottle | (grams) | (grams) | (grams) |
| PET A (Suspension) | 19.95 | 20.23 | 0.28 |
| Glass A (Suspension) | 151.52 | 152.04 | 0.53 |
| Glass B (Suspension) | 148.65 | 149.07 | 0.42 |
| PET B (Molten) | 19.99 | 20.19 | 0.19 |
| Glass C (Molten) | 147.29 | 147.45 | 0.15 |
| Glass D (Molten) | 147.16 | 147.46 | 0.29 |

The surface texture of the liquid-impregnated surface formed on the inner surface of the PET bottles A and the PET bottle B were analyzed using an interferometer (Taylor Hobson, CCI HD) to determined the roughness parameter and complexity of the liquid-impregnated surfaces. The measured roughness parameter of the liquid-impregnated surface formed on the PET A bottle was 14.9% at the first location and 22.0% at the second location, and the measured complexity was 12.7% at the first location and 18.5% at the second location. In comparison the measured roughness parameter of the liquid-impregnated surface formed on the PET B bottle was 6.12% at the first location and 7.46% at the second location, and the measured complexity was 5.22% at the first location and 5.38% at the second location.

### Example 6: Heating or Cooling the Substrate

In this example, the substrate on which a solution of the solid particles was spray coated was heated or cooled prior to spray coating to control the properties of the textured surface. A 3% solution of carnauba wax was prepared in ethyl acetate. To prepare the solution, 1.5 grams of carnauba wax was added to 50 ml of ethyl acetate. The solution was heated and stirred until the carnauba wax solid was completely dissolved in the ethyl acetate solvent to form a stable solid particle solution. The solid particle solution was then cooled down to room temperature. The cooled solid particle solution was filled in the glass jar of a SpriMag™ spray coater. The spray coater was calibrated to deliver substantially the same weight of the solid particle solution on spraying for a predetermined period of time, from a first spray coat to a second spray coat and so on. The solid particle solution was spray coated on an inner surface of a first 8 oz PET bottle, a second 8 oz PET bottle, and a third 8 oz PET bottle such that each bottle was spray coated for the same amount of time. The three PET bottles were substantially similar to each other. The weight of each of the bottle was measured before coating. The first PET bottle was heated to a temperature of about 65 degrees before coating, the second PET bottle was cooled to a temperature of about 0 degrees Celsius before coating, and the third PET bottle was maintained at room temperature. Each of the PET bottles was weighed before and after the spray coating process to determine the weight of the deposited coating. The adhesion of the solid particle coating on each of the PET bottles was studied by applying friction to the coating. No substantial difference in weight was observed between the first PET bottle, the second PET bottle, and the third PET bottle. However, some enhancement in the adhesion of the solid coating to the inner surface of the heated first PET bottle was observed because of the localized melting and resolidification of the solid particles spray on the heated surface.

### Example 7: Spraying Solvent on a Solid Particle Coating

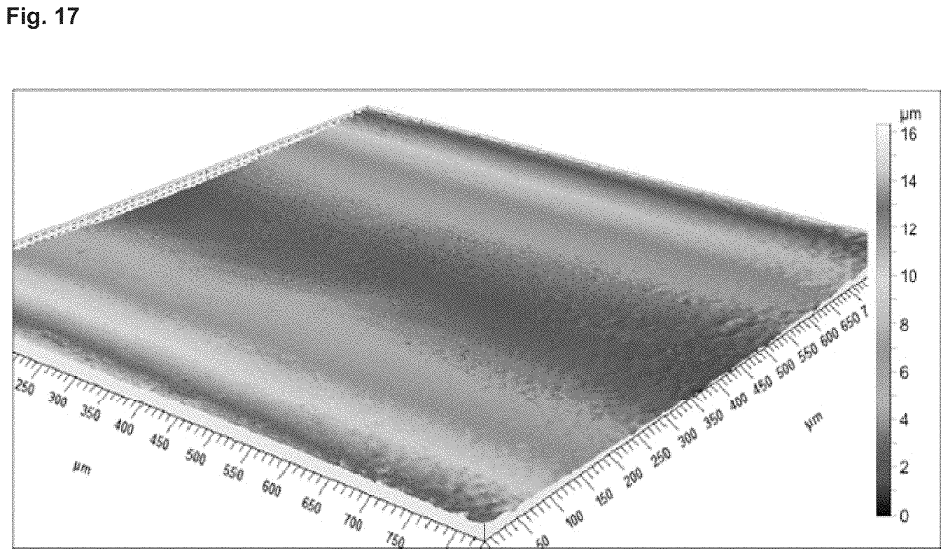

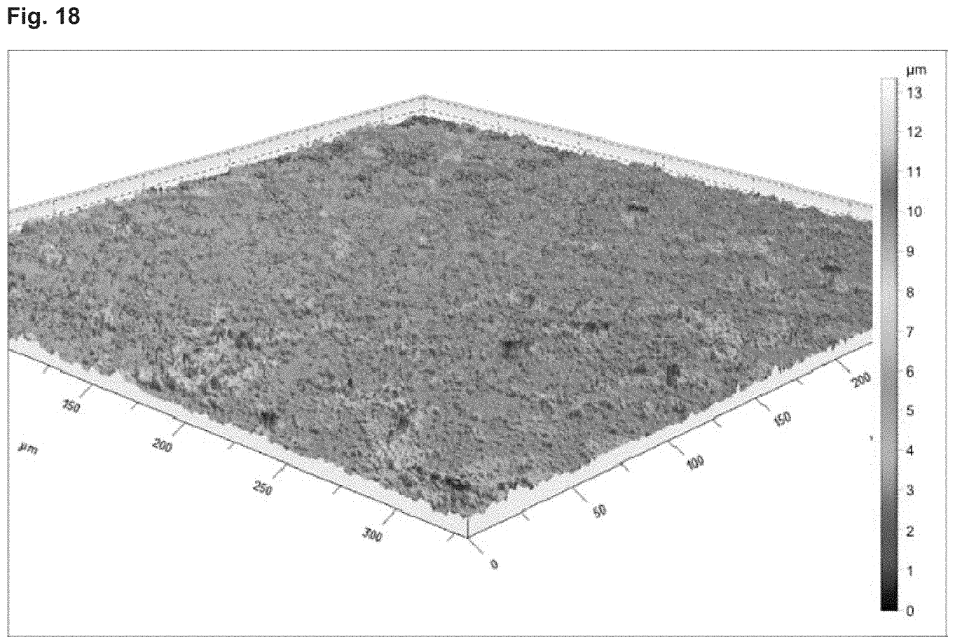

A smooth coating of beeswax was disposed on a surface. FIG. 17 shows an interferometry image (Taylor Hobson, CCI HD) of the smooth beeswax coating. The complexity of the coating was about 1.2%. Ethanol heated to about 80 degrees Celsius was sprayed onto the beeswax coating and then allowed to evaporate. FIG. 18 shows an interferometry image (Taylor Hobson, CCI HD) of the beeswax coating after the spray treatment with ethanol. The coating looks visibly rough and has a complexity of about 55%.

While various embodiments of the systems, methods and devices have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. For example, in some embodiments, multiple spray coats of a heated solid particle solution can be deposited on a substrate which can then be heated in an oven or N2 dried, multiple spray coats of a solid particle solution that includes solid particles suspended in an impregnating liquid can be performed, or any other combination of the various embodiments of the spray coating process described herein can be performed. The embodiments have been particularly shown and described, but it will be understood that various changes in form and details may be made.

1. A method comprising:
forming a solid particle suspension comprising a plurality of solid particles, the particles of the plurality of solid particles having an average dimension of between about 5 nm and about 200 μm;
applying the solid particle suspension to a surface by spray-depositing the solid particle suspension onto the surface; and
applying an impregnating liquid to the surface, the plurality of solid particles and the impregnating liquid collectively producing a liquid-impregnated surface comprising the plurality of solid particles.

2. The method of claim 1, wherein the solid particle suspension further comprises a surfactant.

3. The method of claim 2, wherein the surfactant includes at least one of oleic acid, elaidic acid, vaccenic acid, linoleic acid, caprylic acid, capric acid, lauric acid, myristic acid, palmitic acid, stearic acid, arachidic acid, beeswax, docosenoic acid, trans-13-docosenoic acid, cis-13-docosenoic acid, nonylphenoxy tri(ethyleneoxy) ethanol, and a fluorochemical.

4. The method of claim 1, wherein the particles of the plurality of solid particles have an average dimension of between about 10 nm and about 100 μm.

5. The method of claim 1, wherein particles of the plurality of solid particles have an average dimension of between about 5 nm and about 1 μm.

6. The method of claim 1, wherein particles of the plurality of solid particles have an average dimension of between about 1 μm and about 50 μm.

7. The method of claim 1, wherein the plurality of solid particles comprises a first plurality of solid particles having a first average dimension and a second plurality of solid particles having a second average dimension, the second average dimension different from the first average dimension.

8. The method of claim 1, further comprising:
roughening the surface prior to the spray-depositing.

9. The method of claim 8, wherein the roughening comprises at least one of chemical etching, mechanical etching, pre-texturization by injection molding, and blow molding.

10. The method of claim 1, wherein the spray-depositing is performed using at least one of a SpriMag™ sprayer, an air sprayer, an air-less sprayer, an ultra-sonic spray coater, a thermal spray coater, a plasma spray coater, an electric arc spray coater, and a powder spray coater.

11. The method of claim 1, wherein the solid particle suspension comprises the impregnating liquid.

12. The method of claim 1, wherein the applying the impregnating liquid is performed after the applying the solid particle suspension.

13. A method comprising:
forming a solid particle suspension comprising a solvent and a plurality of solid particles, the particles of the plurality of solid particles having an average dimension of between about 5 nm and about 200 μm;
applying the solid particle suspension to a surface by spray-depositing the solid particle suspension onto the surface;
allowing at least a portion of the solvent to evaporate, thereby producing a textured surface; and
applying an impregnating liquid to the textured surface to produce a liquid-impregnated surface.

14. The method of claim 13, wherein a weight by weight concentration of the solvent in the solid particle suspension is in the range of about 50% to about 99.9%

15. The method of claim 13, wherein the plurality of solid particles comprises at least one of: an insoluble fiber, a wax, a polysaccharide, a fructo-oligosaccharide, a metal oxide, montan wax, lignite, peat, ozokerite, a ceresin, a bitumen, a petrolatun, a paraffin, a microcrystalline wax, lanolin, an ester of metal or alkali, flour of coconut, almond, potato, wheat, pulp, zein, dextrin, a cellulose ethers, ferric oxide, ferrous oxide, a silica, a clay mineral, bentonite, palygorskite, kaolinite, vermiculite, apatite, graphite, molybdenum disulfide, mica, boron nitride, sodium formate, sodium oleate, sodium palmitate, sodium sulfate, sodium alginate, agar, gelatin, pectin, gluten, starch alginate and carrageenan.

16. The method of claim 13, further comprising:
controlling an atomizing air pressure.

17. The method of claim 13, the method further comprising controlling a temperature of the solid particle suspension during the spray-depositing

18. The method of claim 13, the method further comprising modifying a temperature of the surface before spray-depositing

19. The method of claim 13, the method further comprising modifying a temperature of the surface during spray-depositing

20. The method of claim 13, the method further comprising heating or cooling the surface after spray-depositing

21. The method of claim 13, the method further comprising controlling at least one drying condition and/or a drying time of deposited solid particles after the spray-depositing.

22. The method of claim 13, wherein applying the solid particle suspension to the surface includes applying a first coating of the first solid particle suspension, the method further comprising spray-depositing a second coating, of a second solid particle suspension.

23. The method of claim 22, further comprising drying at least a portion of the first coating prior to the spray-depositing the second coating.

24. A method comprising:
forming a solid particle suspension comprising an impregnating liquid and a plurality of solid particles, particles of the plurality of solid particles having an average dimension of between about 5 nm and about 200 μm; and
applying at least one coating of the solid particle suspension to a surface by spray-depositing the solid particle suspension onto the surface, thereby producing a liquid-impregnated surface.

25. The method of claim 24, wherein the solid particle suspension further comprises a solvent, and a weight by weight concentration of the solvent in the solid particle suspension is less than about 50%

26. The method of claim 24, wherein the impregnating liquid comprises at least one of: silicone oil, a perfluorocarbon liquid, a halogenated vacuum oil, a grease, a lubricant, a fluorinated coolant, an ionic liquid, a fluorinated ionic liquid that is immiscible with water, a silicone oil comprising PDMS, a fluorinated silicone oil, a liquid metal, a synthetic oil, a vegetable oil, an electro-rheological fluid, a magneto-rheological fluid, a ferrofluid, a dielectric liquid, a hydrocarbon liquid, polyalphaolefins (PAO), a fluorocarbon liquid, a refrigerant, a vacuum oil, a phase-change material, a semi-liquid, polyalkylene glycol, an ester of a saturated fatty acid or dibasic acid, polyurea, synovial fluid, and a bodily fluid.

27. The method of claim 24, wherein the solid particles are molten.
